(19) United States
(12) Patent Application Publication
(10) Pub. No.: US 2012/0028229 A1
(43) Pub. Date: Feb. 2, 2012

(54) Augmented simple abacus with an underlying grid of numbers or a blank sheet

(76) Inventor: James Richard Harte, Kansas City, MO (US)

(21) Appl. No.: 12/804,825

(22) Filed: Jul. 30, 2010

(51) Int. Cl. G09B 19/02

(52) U.S. Cl. 434/203

(57) ABSTRACT

This invention is about adding additional parts (augmentations) to a simple abacus to enhance its effectiveness when used by beginning learners in: learning to count numbers from one to one hundred; to learn addition and subtraction; and to later learn other math processes. And these (augmentations) are of four main types: 1.) blank sheets to be written on by the student, parent or teacher; 2.) larger blank sheets to hide unneeded rows of beads and unneeded numbers. 3.) printed grids of numbers where these numbers are in a are sequence of numbers from #1 to # 100, where these numbers are divided Into ten segments that correspond to ten rows of beads; and where each printed number appears above a bead in the counting area; and 4.) a second type of printed grid of numbers that are the “products” of a multiplier and a multiplicand (which are ten or under in value.)

### CROSS REFERENCE TO RELATED PATENTS

| Numbers | U.S. Patents Granted: | | Filing Date | Class/Subclass |
|---|---|---|---|---|
| 271784 | Stewart | Feb. 6, 1883 | Nov. 15, 1882 | (now) 434/203 |
| 422612 | Neuhaus | Mar. 4, 1890 | | (now) 434/203 |
| 452302 | Dennison | May 12, 1891 | | (now) 434/203 |
| 580516 | Andrew | April 1897 | Oct. 2, 1896 | (now) 434/203 |
| 1,142,651 | Winiecki | June 1915 | May 22, 1914 | (now) 434/203 |
| 1,694,405 | Troidl | Dec. 11, 1928 | Jul. 22, 1926 | (now) 434/203 |
| 3,092,917 | Podell | Jun. 11, 1963 | Jun 16, 1961 | 434/203 |
| 3,672,072 | Aklyama | Jun. 27, 1972 | Dec. 11, 1970 | 434/203 |
| 5,334,026 | Yilato | Aug. 2, 1994 | Jul. 7, 1993 | 434/203 |
| 5,725,380 | Kennelly | Mar. 10, 1998 | Jan. 14, 1997 | 434/203; |
| | | | | 434/192 |
| 5,769,639 | Foster | Jun. 23, 1994 | Apr. 19. 1994 | 434/154; |
| | | | | 434/167 |
| 6,375,468 | Sundar- | Apr. 23, 2002 | Jun. 24, 2000 | 434/203 |
| | arajan | | | |

### NO FEDERAL FUNDS WERE USED IN THE RESEARCH OR IN THE DEVELOPMENT OF THIS PATENT APPLICATION

### NO SEQUENCE LISTING; HARD OR SOFT COMPUTER DISC; OR COMPUTER PROGRAM WAS USED WITH THIS PATENT APPLICATION, OTHER THAN THE USE OF A WORD PROCESSOR

### BACKGROUND OF THE INVENTION

### Field of this Invention

This invention pertains to teaching and learning tools. And more specifically it relates to the use of an augmented or modified simple abacus to be used with and by very young children, and others, to help then learn to count numbers from one to one hundred; and to help them understand the concepts of: addition, subtraction, multiplication, division, the multiplication tables, fractions, and the value of unknown numbers.

And one of these augmentations or modifications to a simple abacus is to place a grid of printed-numbers or a blank sheet beneath ten rows of rods or ropes that have ten beads on each rod or rope, and are located within a strong square or rectangular frame, (with no bottom). And this grid of numbers that are printed on a sheet of paper or plastic like material. can be fastened to the bottom of this frame in a number of ways. Or this sheet can be placed on a desk top or table top, unfastened to the bottom of the frame of a simple abacus. Or the user, or parent, or teacher may later choose to fasten this blank sheet to the bottom of this abacus frame, and to write, or paste, numbers or symbols on this blank sheet at specific locations. And on the rods or rope segments in this simple abacus are normally ten movable beads per rod or per rope segment.

A simple abacus is different from a traditional type of abacus. A traditional type of abacus has beads of two different values on the same: wire, rod, or rope segment. In a traditional abacus a “counting bar” separates the beads on the same rod into a group of ten beads on one side of the counting bar, and one bead on the other side of this “counting bar” But the beads are only given a value when they or their group are pressed against the counting bar. And on the first rod or rope segment, each of the ten beads is given a value of one each, when that bead, or that group of beads touches the counting bar. And the single bead on the first rod is given a value of ten when it touches the counting bar. And in a traditional abacus, the beads on each successive rod or segment of rope is worth ten fold the amount of a similar bead on the preceding rod—when these beads touch the counting bar. If a bead does not touch the counting bar or is in a group that does not touch the counting bar, that bead and that group are of no value. See FIG. 1, for an illustration of a traditional abacus.

A simple abacus has only one type of bead, but has ten beads per rod or per segment of rope. And with a simple abacus, all beads are of the same value, usually one. And with a simple abacus a bead, or a group of beads are only given value, if that single bead, or that group of beads touch the counter bar. And the counter bar is usually the left side edge piece of the frame of that simple abacus, when the rods that hold the beads are in a horizontal direction. And simple abacuses are usually used to help beginning learners learn the numbers from one to ten, by moving one bead at a time from the “non-counter area” (near the right side of the abacus) to the left so that each bead touches the “counter bar” (usually the left edge piece). And on a simple abacus the first rod (which contains the first row of beads), has ten beads on it that help the beginner learn to count from one to ten. And the second rod also contains ten beads. But as these beads are pushed against the “counter bar”, these beads are called beads number: 11, 12, 13, 14, 15, 16, 17, 18, 19, and 20, And the third rod also has ten beads on it. But these beads are not given a value of one each until they are pushed against the left edge piece, or are pushed against other beads that are pushed against the left edge piece. And on a simple abacus there may be a total of ten rods (or segments of rope). And these additional rods are to help the beginning learner, learn the progressive sets of ten numbers in the twenties, thirties, fourties, fifties, sixties, seventies, eighties, and nineties (of which the last number is 100.)

The abacus was used by the Romans at the time of Julius Caesar. The Romans did their calculations on an abacus, and then wrote down the numbers in Roman numerals on paper like papyrus or parchment with ink. Archaeologists have found Roman abacuses made with bronze and wooden frames, with beads made of wrist bones, ceramic and glass beads, and wooden balls, with holes bored through them so they could be moved back and forth on bronze wires, strings, or on wooden or metal rods.

Until the early 1700's Roman numerals and abacuses were widely used in Europe to help keep records of numerical data. Although the Arabs introduced the Arabic system of numerals and the zero, into Southern Spain in the 1200's; the Arabic system of numbers was not widely used until in the early 1700's in many parts of Europe. And with Roman numerals, the abacus was in common use in Europe.

The most common type of abacus used by the Romans and others had a number of parallel rods of the same diameter and length. And these rods were held within a frame. And on each rod were beads of two values. And this type of abacus is what I refer to as a traditional abacus. Please see paragraph [0005] for details.

And one variation of this current invention is what I call an: Augmented Simple Abacus With an Underlying Printed Grid of Numbers or a Blank Sheet; And I use a simple abacus that has only ten beads per rod, (or short segment of rope), and all beads on all rows, have a value of one when they, or their group, touch the counting bar. And when an individual bead, or that group of beads, touches the right hand edge piece (the non-counting bar) these same beads now have no value.

Simple abacuses are used primarily to help young children learn how to count and to learn how to add and subtract small numbers. And in this use of a simple abacus, all beads have a potential value of one. And in using a simple abacus in this way, all ten locations for a counter bead on a rod are to be filled before you (the user) start working with the ten next ten beads on the next lower rod.

I first encountered the wide use of an abacus in September 1946, in Seoul, Korea, by merchants in their shops, while I was in the U.S. Army. And I purchased several abacuses of conventional or traditional type, while I was in Korea. And these Abacuses were a novelty to many of my friends and relatives when I returned to the USA.

And after medical school, I went into the specialty of psychiatry, and then into child and adolescent psychiatry as my chosen area of work. And between 1957 until I retired in 2003, I spent about 80% of my work time in the area of child and adolescent psychiatry. And in addition to the presenting problem of many of the children and adolescents that I saw and evaluated, some of these children and adolescents had significant problems mastering number concepts. And at times I kept an abacus in my desk, and used it to explain our numbering system with a “base of 10”. And I built a number of abacuses from wood strips; plus wooden or metal rods; plus glue; plus brads or screws; plus beads of various types and sizes. But I found that small diameter beads were a real menace for small children when the abacuses were broken, and the beads were released. And small children liked to put these beads in their mouth. And this presented the real risk of a small child choking on an aspirated small bead that was sucked into their lungs. So I then started using larger diameter beads, to greatly lessen the risk of a small child choking on a bead.

And in the more recent models of simple abacuses that I have built, I have used wooden beads of 0.9 inches in diameter, with an 0.25 inch hole bored through each bead. And I have used a sheet of ¼ inch thick plywood cut to a dimension of 18 inches wide and 12 or 16 inches from top to bottom. And along each side edge I have glued and stapled these strips of wood that are 12 or 16 inches long, 0.75 inches wide, and 0.8 Inches high. And each of these two strips of wood have 10 parallel holes drilled through them that are about one inch or 1.4 inches apart along their 12 or 16 inch length. And the two side edge pieces have ten sets of two holes per set that are 0.25 inches in diameter, And the centers of these holes in each of the two edge pieces are about 0.5 inches above the flat surface of the plywood. This 0.5 inches above the flat bottom surface allows these beads to be moved freely back and forth above the printed grid of numbers which is placed on the flat bottom surface. Thus these beads can be easily moved from the counting area to the non-counting area and back. And each set of two holes is in the same axis, so that a single ¼ inch diameter rod easily goes through a 0.25 inch hole in the left and right side edge pieces, on the same axis. And with this arrangement of holes, a ¼ inch diameter rod, rope or cord, can be pushed through each of these ten sets of 2 holes per set. And ten beads can be placed on each rod, or on each segment of rope or cord.

And with the above arrangement, a ¼ inch diameter rope can be threaded through the top hole on the left side wooden edge piece; and then through the ¼ inch holes in ten wooden beads; and then through the top hole in the right hand edge piece. And the rope can then be looped around and then threaded through the second hole from the top in the strip of wood on the right hand edge piece. And then ten beads can be threaded on this rope. And this rope can then be threaded through the second hole from the top in the left side wooden edge piece. And we can then put a second group of ten beads on this second segment of rope, before we thread this rope through the second hole from the top in the right hand edge piece.

And in a similar way the rope or cord can be threaded through the eight other sets of two holes in the left and right side wooden or molded plastic edge pieces. And also ten beads can be placed on each segment of rope or cord, each time it is passed through one set of two holes in the two wooden or plastic side edge pieces. (Or ten wooden or metal rods can be used for this purpose in place of one long rope or cord.)

And to work with the above arrangement, I have printed sheets of paper with a grid of numbers, where numbers from # 1 to # 10 (font size 36) are printed in a left to right manner in the top row of numbers. And numbers # 11 to # 20, are printed in the second row of numbers. And numbers # 21 to # 30, are printed in the third row of numbers. And so on until the last row of beads and numbers contains numbers 91 through number 100. (See FIG. 2 for details).

And this simple abacus is augmented by the placement of this printed grid of numbers, so that when a bead, or a group of beads is pressed against the “counter bar” the number appearing beneath, but slightly above or slightly below that bead, gives that bead its number in this arrangement. See FIG. 2 for an illustration.

And in the above described arrangement, each printed number appears beneath, but slightly above a counter bead that is in that position in its proper number sequence; if that bead has been moved from the “non-counter group” into the “counter group” (This assumes that the rods that are nearer the top of this simple abacus have been filled.) And the centers of the beads are about 0.9 inches apart when they are on the rope, cord, or on a wooden or metal rod, and have been pushed against the left edge piece (the counter bar). And the centers of the grid of printed numbers are also about 0.9 inches apart on this printed grid of numbers when it is placed beneath the rows of wooden or plastic beads—when the beads touch the “counter bar” (the left edge piece.) See FIGS. 2 and 3 for an illustration of this.

And for beginners who are just learning about numbers, their value, and how to count them, and how to add and subtract them; they can first work with only the top one row of ten beads, while under the supervision of an older and more knowledgeable person. And in the top row of numbers are #1 to # 10. And after the beginner has mastered the counting of one to ten, and has also mastered, or at least understood the concepts of addition and subtraction of numbers with a sum of ten or less; then a second row of ten beads can be added. The second row of beads are for the ten numbers, # 11 to # 20. And the beginning learner can then use this total of 20 beads to learn to count to twenty; and also to learn to add and subtract numbers with a sum of twenty or under.

And to not overwhelm the beginning learner with the printed grid of one hundred numbers, plus 100 wooden beads; I have made it possible for the parent, tutor, or teacher to initially limit the number of beads to only the first row of ten beads, and ten printed numbers. And slightly later a parent or teacher can add a second group of ten beads to the first group of ten beads. Thus the new learner then becomes exposed to two rods with ten beads per rod. And if the new learner appears to be confused by the large grid of numbers; a plain sheet of white unmarked paper can be placed over the lower part of the grid of numbers to lessen the amount of data that has to be dealt with. Thus if the upper two rows of printed numbers are being worked with, the lower eight rows of ten printed numbers per row can be covered to lessen distraction and possible confusion in the new learner.

There is a potential problem of having a beginning learner being overwhelmed initially by ten rows of beads, with ten beads per row; plus also having printed numbers from # 1 to # 100 potentially beneath each of these many beads. This problem is partly solved by the type of construction this simple abacus, so that the beginning learner may be initially confronted with only one new row of ten beads at a time. This type of construction is to have each wood or metal rod held in position by a wood screw. This allows the parent, tutor, or teacher to add only one row of ten beads at a time, as the student progresses in their mastery of counting numbers, and in their mastering the concepts of addition and subtraction. The same goal of introducing only one set of ten beads at a time can also be achieved by the use of a long cord or long rope. And with this cord or rope, the teacher, parent, or tutor can add one unit of ten beads at a time by threading this cord through one of the holes in the edge pieces, then placing ten beads on this rope or cord; and then threading this cord through the hole on the same axis on the opposite edge piece. The purpose of this is to prevent “overload” and confusion in the beginning learner, by helping them avoid too much information at the starting point. Thus this simple abacus is set up to add ten beads with one wood or metal rod plus 10 beads at a time, (or adding one segment of rope or cord plus ten beads at a time), if the parent or tutor so chooses.

And another part of preventing “overload and confusion”, in the beginner is to also cover the part of the grid of numbers that is not being used, with a blank sheet of paper. This is illustrated in FIG. 7.

FIG. 8, shows a similar type of blank sheet. But in FIG. 8, this bank sheet is located above the rows of beads and the rows of rods. And in FIG. 8, this blank sheet is taped to the two side edge pieces with four short pieces of adhesive tape And as the user masters the rows of beads and numbers, the sheet can be moved down.

And as I looked at this grid of ten beads by ten beads, I thought that this type of grid could also be used to teach the multiplication tables, and also be used to teach beginning multiplication and division. But this would require a second and different type of printed augmentation to help teach the multiplication tables, and division and multiplication. And I then used the numbers that are the “products” that are produced when two numbers that are both ten or under, are multiplied together, to construct this second type of grid. (See FIG. 10 for details.)

In paragraph # 24 above, I have introduced a second type of augmentation that can extend the use of a simple abacus. And this second grid of numbers can help a learner, learn about multiplication and division and the multiplication tables. And the numbers printed in this second grid of numbers can be printed on the opposite side of the sheet of paper that contains the first grid of numbers.

And in thinking about other uses for this simple abacus, it occurred to me that another type of augmentation could be a “Blank Sheet” that is placed under the ten rods with ten beads per rod. And a blank sheet could be filled in by a parent, tutor, or teacher to teach another type of possible subject matter where this simple abacus could be used. And as an example of a possible additional use, is to help the learner understand the concepts of “unknown numbers”, and of simple equations. And in FIG. 12, I have taken a blank sheet of paper and placed it under the ten rows of beads in a simple abacus. And then I pushed all ten rows of beads to contact the left edge piece (the counter bar) And then above the left hand column of beads, I wrote the numbers: 1, 2, 3 4, 5, 6, 7, 8, 9, and 10; above each bead as I went down this column of beads. And then above the top row of beads, I left #1 in the far left hand position. And above beads number two through ten, I wrote letters of the alphabet (in place of the numbers two through ten.)

And the more advanced student could be given the challenge to pick out one of the letters in the top row of: number “1” plus nine letters of the alphabet. And the student is then directed to pick out a number in the left hand column of numbers. And next the student is asked to build a square or a rectangle of beads in the counter area. And this square or rectangle of beads includes the area in the counter area that is defined by the number that has been picked out from the left hand column; and also by the letter of the alphabet that has been picked out. And next the student is asked to count the number of beds in the square or rectangular counter area. And next the student is then asked to set up an equation such as: “5 times T equals 25”. And the student is to solve this simple equation for the value of letter T. And the student is then told the “math rule” that equals divided by equals are equal. Thus the student can divide both sides of this equation by the number 5 And the student then ends up with the answer, which is: T=5. And thus young students can be given the concept of how to solve an equation that contains one unknown number. And they can see and experience this process of solving an equation in a simple and concrete way by the use of a blank sheet that had been written upon by a parent, tutor, or teacher. And this is illustrated in FIG. 12.

With my current model of the: AUGMENTED SIMPLE ABACUS WITH AN UNDERLYING GRID OF NUMBERS OR A BLANK SHEET, there are ten wooden beads that measure 0.9 inches in diameter in each row. And there are ten rows of beads from the top row through the bottom row. And the space occupied by the printed grid of numbers occupies the left half of the 18 inch×16 inch plywood flat surface. And the right half of the flat plywood surface has no printed matter on it's surface. But the wood or metal rods, or the segments of rope extend over both the left half and the right half of this flat surface. This allows the user to move the breads on a rod or on a rope from the right half (the non-counting area), to the left half (the counting area) and back, as the beads are manipulated by the user. And this arrangement of having a large blank (unprinted) space on the right hand side of this augmented simple abacus, makes it much easier to present the multiplication tables And this large blank space on the right hand side in the “non-counting” side allows the squares and rectangles of beads on the left hand side (inside of the counter area), can be viewed without obstructions by the non-counting beads.

Thus if the beads are two beads wide and two beads high in the counting area (contacting the left edge piece), the number 4 will appear above the second bead in the bottom row, if this second type of printed grid lies under the beads in the counting area. And if the beads in the counting area are four rows high with four beads per row, the number 16 will appear above the forth bead in the fourth row—with this second type of printed grid of numbers. And the slightly advanced learner can see in a “concrete” way how multiplication, division, and the multiplication tables work. See FIGS. 17 through 20, for illustrations of this.

In a typical abacus, and also in this simple augmented abacus, the beads that have no value are pushed away from the “counting bar”. And the beads have a value of one or more per bead are pushed against the counting bar. In this current design of an augmented simple abacus, the left wooden edge piece is used as the counting bar. And for beads that are neutral, or are of no value, these beads are pushed against the right side wooden edge piece (the non-counter bar).

The reasons for such a large working surface (18″×16″) are explained below.

1.) For beginning learners, of three, four, and five years of age, they appear to learn better and quicker from large items, large images, or large objects; than from small Items, small images, or small objects;

2.) A large space is needed to accommodate 100 large wooden beads of 0.9 inches in diameter for each bead; Plus space is also needed for one hundred numbers. Plus space is also needed in the “non-counting” area on the right hand side of the abacus, to temporarily store the beads that are not being actively used.

3.) And for beginning learners I want sufficient space above the flat plywood work surface or a flat desk top, for the “non-counters” to be pushed and stored on the far right side, to make it clear to the user that for the moment these beads are of no value, and are being put in an “out of the way place” for the moment.

A significant part of the background for this invention is my interest and my participation as a consultant with 64 Child Day Care Centers in the City of San Fernando, in La Union Province, in the Philippines for the past five years. These 64 Child Day Care Centers together enroll about 4000 children per year who are three thru six years of age. In the Philippine Public Schools, they have no kindergarten. And children start first grade at six or seven years of age. And many communities have a large number of Child Day Care Centers. Some of these Child Day Care Centers are privately owned and operated; and others are partly locally tax supported and partly supported by tuition.

Prior to five years ago, I was involved with two public schools in San Fernando, La Union Province, in the Philippines, to evaluate the benefit of some of my ideas and related materials that I had developed to help young children learn to read English words by a phonics based method. And several children in the community of San Fernando, La Union, were tutored at home from age four years by this method by their parents. And these children made amazing progress in learning to read English words and in learning English phonics when they were started at four years of age with these two types of reading materials for four or five days per week for two years at home. And when this became known by the local Rotary Club, these Rotary Club members established a literacy committee to look into what should be done with this knowledge. And some of these literacy committee members contacted 25 of the 64 Child Day Care Centers in San Fernando, La Union, to see if they were interested in using this method to have the children in their Child Day Care Center learn English phonics and also learn some English words by these methods. And I was asked by e-mail by some of the members of this literacy committee, if I would participate in setting up a program to help teach these pre-school age children English phonics and to read some English words by these methods. And I was agreeable to do this, with some help from local educators. And I supplied two types of teaching materials, and explained to about 100 child day care workers, and educators, how to use these materials. And this was done with the understanding that at some point in the future, we would test their graduates from Day Care to see how well they had learned English phonics and some English words. And this was a very successful effort on the part of many involved persons. (Some of the details of this are present in my pending patent application: “Progressive Synthetic Phonics”, which has been given application Ser. No. 12/589,878.)

But in recent months I have been thinking, about the pre school age children in these 64 Child Day Care Centers. And I thought: “Wouldn't it be nice if these wonderful child day care workers could also teach some of their three thru six year old children, the numbers from one to one hundred, and also teach them some of the simpler concepts of addition and subtraction?” And as I thought about this, I thought the best way to do this with three, four, and five year old children was with a large simple abacus, that was modified or augmented to meet the developmental needs of very young children.

And as I thought about this, I thought that one of the problems was that many of these 4000 children from three years to six years of age, don't even know their numbers from # 1 to # 20. Therefore, a simple abacus must be augmented or modified so that each very young child of 3 or 4 years of age, could clearly see the relationship between the number of beads in a row, and also see the written number symbol for that number above each bead, in a row of ten beads. Thus the numbers: 1, 2, 3, 4, 5, 6, 7, 8, 9, and 10 should be written slightly above (or slightly below) each bead in the top row of ten beads that are in contact with the left edge of the abacus frame (the counting area). And printed numbers: 11, 12, 13, 14, 15, 16, 17, 18, 19, and 20 should be printed in the second row of numbers, on the same sheet of paper. And this printed grid of numbers should be placed beneath the first and second rows of beads that contact the left edge piece of the frame in “the counter area”. And the other eight lower rows of ten beads per row should have their numbers printed slightly above or slightly below each bead. in a similar manner; (when these beads are pressed against the left edge piece.)

And as I thought about this, I thought that perhaps I should just have sheets of paper printed so that the grid of written numbers, from one to one hundred, appeared in ten rows of numbers underneath (but above or below) each of the 100 large beads in ten rows of beads that had ten beads per row. And in this way, each bead was represented by its own particular number. And that the child care workers could be shown how to use this system to help children understand or comprehend the written numbers, from number one to number 100. And that the child day care workers, parents, or teachers, could also be shown how to use this modified or augmented simple abacus to help young children learn some of the concepts of simple addition and subtraction.

And I then thought it was appropriate to see if anyone else had previously developed this type of augmented simple abacus. And I went to a giant children's toy store. And they had a number of types of abacuses, but none were like my “augmented simple type” of abacus; where a printed grid of numbers was placed beneath the rows of beads, and where the individual numbers appear on a printed sheet, slightly above or slightly below each bead that was located on the left side of the abacus in the “counter area”; and directly or indirectly touching the counter bar.

And I recently gave one of these simple augmented or modified abacuses to my grand daughter and her husband at a family “Mother's Day” get-together to use with their four year old son. And I was very impressed at how rapidly on Mother's Day, he picked up the ideas. And he was able to do simple addition and simple subtraction with numbers below 20 with this simple augmented abacus under the supervision of his mother and/or father on Mother's Day, 2010, with less than two hours of help.

And I then thought I should see how much information I could get from the U.S. Patent Office via e-mail, to start my search as to what had been done previously in this area of modified or augmented simple types of abacuses, to be used by very young children under the supervision of an older person. And later I got help from three libraries in the Kansas City area to pursue my search:

And as I looked at the large size of this simple augmented abacus, I thought that there must be a better way to construct it. And one of the problems was the large size of the sphere like round wooden beads. And to print a bead's given number above or below a bead took up additional space. And as I thought about this, I thought that a bead does not need to have a sphere like shape. And what I was looking for was a better way to utilize the space above the flat bottom surface of the simple abacus. But I wanted this modified bead to be of a large enough size to make it very difficult for a small child to suck it into their throat or lungs. And I concluded that this could be done by having each bead made of molded plastic, and constructed to have a small diameter tube like part permanently attached to a larger diameter disk like part. And one hole would extend through both the tube like part, and through the disk like part. (Please refer to FIGS. 21 though 24, for an illustrations of this type of bead).

And as I thought about other possibilities for the printed content of this augmentation to place beneath the beads in the counter area of a simple abacus several additional uses came to mind.

Being a child psychiatrist has some benefit in this area, as you understand better than the average person how the brain and mind of children function at different levels of development. And preschool age children seem to learn and remember best, when they use both their major senses (vision, hearing, touch, position sense, and movement sense); and also when their movement systems, or motor systems such as speech (tongue and mouth movements), hand movements, and larger gross body movements are used.

Thus it looked to me like having young children involved with the movements of the beads on a simple abacus, was a very good way to help young children learn about numbers and the different processes in arithmetic, by manipulating the beads on a simple abacus. And this seeing, touching, feeling, moving, speaking about, and discussing, in a concrete way, both the change in the number of beads, and the changes in the printed numbers in the augmentation beneath the beads in the “counter area” (touching the counter bar.) helped them learn about these numbers, And this caused me to increase the number of types of augmentations that may be helpful in learning math concepts, in a concrete and easy to see and easy to understand way. For this see FIGS. 9 through 16, which are described in more detail in under “DESCRIPTION OF THE DRAWINGS”.

### BRIEF SUMMARY OF THE INVENTION

As noted previously in paragraphs [0035] to [0038] I have been a consultant to 64 Child Day Care Centers in the City of San Fernando in La Union Province in the Philippines for the past five years. Together these 64 Child Day Care Centers enroll about 4000 children ages 3 years through 6 years. My becoming a consultant to these 64 Child Day Care Centers came about because of my developing two methods to help children learn to read English words by phonics based methods. And because of the success of these two methods of learning to read at home by these two phonics based methods by several pre-school age children in that community; the Rotary Club of San Fernando, La Union proposed that these two methods be used by 25 of the Child Day Care Centers in San Fernando La Union, if I were agreeable to this. (And the number of day care centers using these two related methods to learn to read English words were expanded to 64 about six months later.)

And I said that I was agreeable to this. And I said that I would provide the two types of materials for these two phonics based methods of learning to read English words; with the provision or understanding that each child day care center would test their graduates from day care as to each child's degree of mastery of this phonics based Information prior to the day of each child's graduation from day care.

And both of my methods for helping children learn to read by a phonics based method uses 160 different three letter English words that could be easily illustrated by a simple black and white drawing. And the goal of both of these methods was for the child to be able to learn the most common spoken sound (phoneme), assigned to each of the letters in each of these 160 three letter words. And each child was to also to learn to blend the spoken sounds of two side by side letters together.

And to help implement this testing, I devised 16 different “Six Part Tests”. And each of these 16 “Six Part Tests”, tested a total of sixty areas of knowledge about ten of these 160 three letter words. (Thus 10 words per test, times 16 tests=160 words tested.) Thus each of the 160 three letter words was included in one of these 16 tests.

And on each test sheet, six questions were asked about ten of these 160 three letter words. (Thus the name “Six Part Tests”.) And the questions asked were as follows: 1.) Name the picture of this object or action. 2.) Read out loud the name of ten printed three letter words. 3.) Draw a line between 10 pictures, and 10 printed three letter words that names or describes a picture. 4.) Give the name of one of the letters in a three letter word, and also give the most common spoken sound (phoneme) assigned to that letter. 5.) Give the spoken sound of a consonant blended with a short vowel, (10 of these). And 6.) give the spoken sound of a short vowel and a consonant when these two sounds (phonemes) are bended together; (10 of these).

And after 12 to 18 months of the children and day care center staff working together with these two methods of learning about English words by learning the phonics of these 160 three letter English words, the day of testing by the “Six Part Tests” arrived.

But about 3½ months prior to testing, I gave each child day care center staff person one copy each, of the 16 page “Six Part Tests”. And I told these child day care center staff that they were free to use these 16 test sheets with their children to prepare their children for a test by one of these 16 sheets—to be chosen at random, at the time of graduation from day care. And I also told the child day care center staff that they were free to share copies of all 16 of these test sheets with any parent who desired copies of these 16 test sheets for use at their home with their child.

And what was the outcome of this testing? Five of the 64 Child Day Care Centers chose not to participate in the testing. The 59 Child Day Care Centers that did participate in the testing had a total of 609 of their graduates randomly take one of the 16 “Six Part Tests”. And I thought their graduates did quite well on this testing. Each test had six parts, with ten questions per part. And all correct responses or correct answers earned one point. Thus there was a possible maximum score of 60 points per test; or a maximum of ten points on each of six parts. (See paragraph [0051] for details.)

And each “Six Part Test” has six “sub-tests”, with a maximum score of ten points per sub-test. And when the scores on the six sub-tests of all 609 students were averaged together, the average score on each of the six sub-tests ranged from 7.0 to 8.2. (out of a possible ten points per sub-test). And a few graduates made perfect scores of ten each, on all six sub tests.

And a second testing a year later, near the end of the school year, gave similar results on the testing of this group of San Fernando Child Day Care Center graduates. And I was verbally told by the administrative director of day care for San Fernando that the use of these two methods of teaching children 160 English words, and their phonics, had become an established part of their Child Day Care Center program.

And I was told several years ago by the director of the Child Day Care Centers of San Fernando, La Union, that the testing of each graduate from day care on one of the randomly selected “Six Part Tests” was also now a part of each day care centers work.

And this past spring in 2010, as I was pondering the information on the previous three pages, I had the thoughts: “What could or should be next?” And: “Wouldn't it be nice if there were an effective way to have the child day care workers of the 64 Child Day Care Centers in San Fernando, La Union help three and four year old children learn to count numbers from one to one hundred; and to learn to add and subtract small numbers?” And as I thought about this, I thought that the best and simplest way to do this would probably be to use a “simple abacus”, that had modifications or augmentations added to this simple abacus to help very young children learn to count. And then the questions to myself were: “What types of augmentations should and could be made for a simple abacus for this purpose?” And these questions set off a train of thoughts that led to the ideas and concepts outlined, and described in some detail in this patent application. And these ideas, concepts, or innovations are described in the paragraphs that follow:

Since my primary interest was to help young children learn to count, and to learn to add and subtract small numbers; it was obvious to me that I was not interested in modifying a commercial or traditional abacus.

Thus my interest was in modifying or in developing augmentations for a simple abacus with ten beads per row of beads; and where all beads had a value of one when that bead or its neighboring beads were pushed against the counting bar.

And as I thought about the mental development of the average three and four year old child, many can not count from one to ten; And many 3 year old to 4 year old children do not recognize the visual image of the Arabic numerals from 1 to 10. And many three year old children to four year old children do not understand the verbal or spoken meaning of the numbers seven, eight, and nine. Thus a reasonable goal was to see if some type of augmentation to a simple abacus could enhance the development of this knowledge and enhance the development of these simple skills.

Thus as I saw this question, the challenge was to find a type of augmentation that could or should help “tie together” or “link together” in a child's mind and memory three things: 1.) the concrete meaning of the spoken words: one through ten; 2.) recognize one to ten similar objects in a row (like beads); and 3.) link the spoken numbers 1 through 10 with the same number of concrete objects; and also link these spoken numbers of 1 through 10 with printed Arabic numerals from one to ten.

And all of the simple abacuses that I have previously seen—and that I have built myself (15 to 20) in the past 40 years; these simple abacuses did not have a way to illustrate the printed Arabic numerals from one to ten, and then from one to twenty, and then from 30 to 100 in a progressive sequential way with this simple abacus. Thus to my way of thinking, what was needed most was an augmentation that was a sheet of paper or plastic that would meet this need of visually illustrating each Arabic numeral of each bead, in the row of beads in a visual way, where this number was printed or written above or below that bead; (when that bead or its neighboring beads were pushed against the counting bar.) Such an augmentation containing printed numbers may exist, but I have not seen one. And in my search, I was not able to locate this type of augmentation.

Thus my number one priority was to devise a printed augmentation that could be placed beneath all of the horizontal rods and the beads on these horizontal rods, when these beads were in the “counter area”, and were pressed against the counter bar. And with this printed augmentation, the numbers I thru 10 would appear above or below each bead in this top row of beads, when all 10 of these beads were pressed against the counter bar.

And a logical extension of the printed numbers in the top row of this augmentation sheet, was to add additional rows of 10 numbers per row that would correspond to the “number location” of the beads, when each bead, and all previous beads were pushed against the counter bar, (the left edge piece).

And the spacing and location of the numbers on this first augmentation sheet, and on all later augmentation sheets should correspond to the locations of the beads above (or below) these numbers, when these beads and all previous beads were in the “counter area”, and are pressing against the counter bar.

And to make this simple abacus with an augmentation that was a grid of numbers, easier to use, I thought it would be best to have a solid permanent flat bottom piece that extended under all parts of the abacus. And this flat bottom surface would provide a location for the proper placement of each augmentation. And removable tape or other fastening means could hold an augmentation in its proper location, on this flat bottom surface. (And I have not previously seen simple abacuses built with a flat bottom surface that would provide a good location for the placement of a printed augmentation sheet.)

And in the past three months, with the simple abacuses that I have built, I have used small plywood sheets for this flat bottom piece. But other material such as “masonite” or hard board may work as well as plywood.

If a person has a simple abacus without a flat bottom surface there are several options for the placement of the augmentation sheet. An augmentation could be printed on a sheet that is large enough to cover the entire bottom of the frame of a simple abacus, and then tape this augmentation to the bottom of the frame of the simple abacus. And another option would be to have this augmentation sheet printed on a sheet of paper that will cover the entire under surface of the abacus that does not have a solid flat bottom. And also printed on this sheet would be four printed lines that outline the four outer edges of the frame of this simple abacus. This would make the positioning of this simple abacus on this printed sheet an easier task. And such an augmentation that contains 4 lines as a printed rim of the outer edges of the frame would make positioning this combination on a desk or table an easy task.

And this first printed augmentation is illustrated in FIG. 9 in the drawings. And this augmentation illustrates the printed numbers from #1 to # 100 where these numbers are divided into ten rows of numbers that correspond to the positions of ten beads per row, in the ten rows in this simple abacus, when all ten beads in all ten rows of beads are pressed against the counter bar. (See FIG. 2 for an illustration.)

And variations of the augmentation shown in FIG. 9 are illustrated in FIGS. 13, 14, 15, and 16. And these variations of FIG. 9, can be used to help a slightly more advanced student learn about: even and odd numbers, and the multiplication tables that include the: twos; the threes; the fives, and the tens. And in a similar manner, the multiplication tables for the: fours; sixes, sevens; eights; and nines can also be made by deleting numbers in FIG. 9, that do not conform to that particular set of multiplication tables

And FIG. 11 is to illustrate a blank sheet that can be used is several ways, one of which is illustrated in FIG. 12.

FIG. 12 is an illustration of a blank sheet that has been set up to help more advanced learners, learn how to use a simple abacus to learn about unknown numbers.

FIG. 10 is a grid of numbers that are set up to show the “products” of a multiplier and a multiplicand, when numbers ten or lower are multiplied together. And the further use of the augmentation shown in FIG. 10 is illustrated in FIGS. 17, 18, 19, and 20.

And FIG. 7 illustrates two things. First, the bottom eight rods (plus their ten beads per rod) have been removed from this simple abacus with a flat plywood bottom. Second, a large sheet of blank paper has been placed over the flat bottom to hide the lower eight rows of numbers on the augmentation. This is to lessen the volume of numbers beginners have to deal with. Too many numbers may cause confusion in some young learners.

FIG. 8 is to illustrate placing a blank sheet of paper or opaque plastic sheet over the lower nine rods with their ten beads per rod. And FIG. 8 also shows taping this bank sheet to the left and right side edge pieces. The purpose of this blank sheet is to reduce the number of rods and beads that are visible to a beginner. And the beginner can start working with to only one rod with ten beads on this rod. And in FIG. 8, seven beads are in the counter area, and are pressed against the counter bar. And three beads are in the non-counter area.

FIGS. 21, 22, 23, and 24 show a type of bead that is composed of two parts; one part of this bead has a small tube like shape; and the second part of this bead has a large disk like shape. The purpose of this type of bead is to reveal more of the space that is under the bead, when this bead is in the counter area. This is best illustrated in FIG. 24. The reason for the large disk like part is to prevent small children from sucking this type of bead into their lungs in the event they are playing with it in their mouth.

And FIGS. 25, 26, 27, and 28 are to show how a simple abacus, without a flat bottom can have an augmentation sheet (FIGS. 25 and 27), placed on a flat surface such as a desk top or a table top, and then have a simple abacus such as the type illustrated in FIG. 3 (which is built with a wooden frame of four parts) accurately positioned over the top of this augmentation sheet. (See FIGS. 26 and 28.) And this can work almost as well as a simple abacus with a built in flat bottom (See FIG. 2.) for accurately positioning a grid of numbers beneath the ten rows of rods, with ten beads per rod. (More details of FIGS. 25, 26, 27, and 28 are described later.)

And FIGS. 25 and 27 are to illustrate how a larger size augmentation that has about one half of its surface area covering the area under the “non-counter beads” can be positioned on a desk top or a table top. And then a simple abacus without a bottom (such as in FIG. 3) can be positioned on top of one of these larger size augmentations. And these two large size augmentations (FIGS. 25 and 27) cover the entire area below the ten rods of this bottomless simple abacus.

In FIG. 3, a smaller size of augmentation, illustrated by # 13, covers only the left half of the area under the ten rods (this is the area occupied by the “counter beads”.) in this bottomless simple abacus.

FIGS. 26 and 28 illustrate how the two types of larger augmentations shown in FIGS. 25 and 27, are positioned under the type of bottomless simple abacus illustrated in FIG. 3.

In FIG. 26, the outer edge margins of the printed augmentation shown in FIG. 25, are located under the rods, and are also located under the frame of this simple abacus, and extend a short distance beyond the exterior parts of this frame. And the dark printed corner parts # 34, and # 35 help to accurately position this simple abacus above this larger augmentation show in FIG. 25.

In FIG. 28, the outer margins of the printed augmentations shown in FIG. 27, Are located within the inner four edge pieces of this four part wooden frame. And the four dark printed corners # 34, are shown just within the four inner corners of the frame of this bottomless simple abacus.

And I believe that having the larger sized augmentations illustrated in FIGS. 25 and 27 make positioning of the printed augmentation beneath the rods of a bottomless simple abacus easier to keep in its proper position, than with the use of the smaller size augmentation illustrated by # 13 in FIG. 3.

### BRIEF DESCRIPTION OF SEVERAL VIEWS OF THE DRAWINGS

FIG. 1. Is a top view of a conventional or typical abacus that has been used for over 2000 years to add and subtract numbers by moving beads located on wires, cords, or rods against or away from the counting bar, (which is given # 1) in FIG. 1. And in FIG. 1, # 2, and, # 3 are non-counting bars. against which beads are pushed to show that they have no value. And in this conventional abacus, on the same rod (# 5) are beads with two different values. And on the top rod, (# 5) are 10 beads (# 4), that have a value of one for each bead, when they or their neighboring beads are pushed against counting bar, # 1.

But beads # 4 loose this value of one per bead, when they or their neighbor are pushed against non-counter bar # 2.

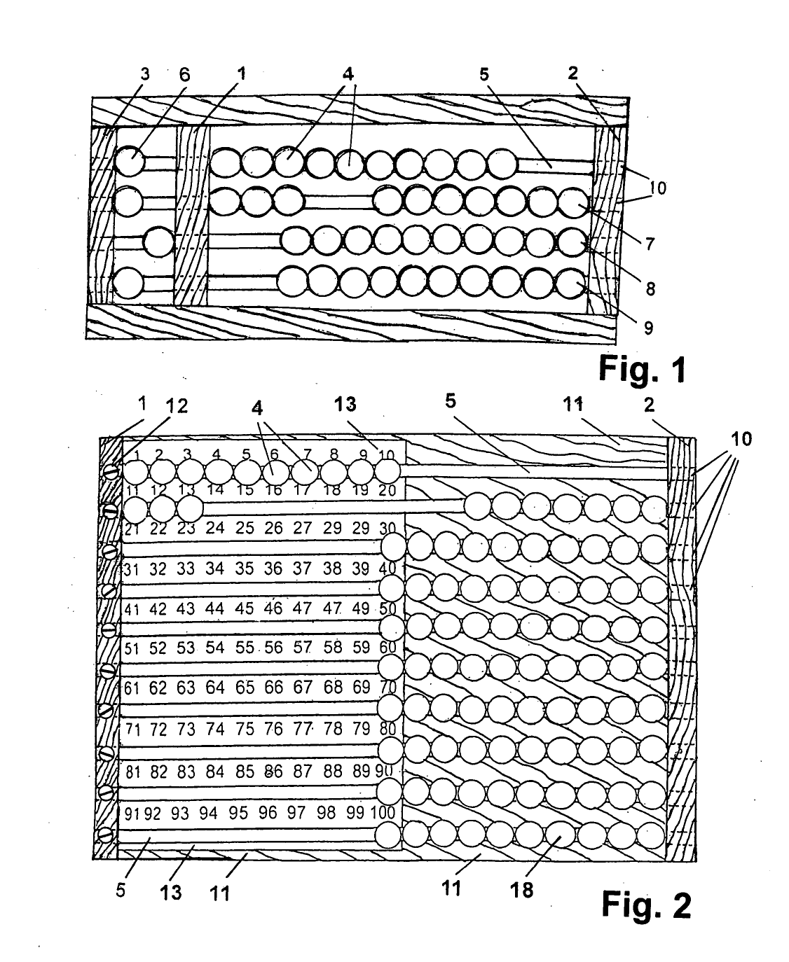

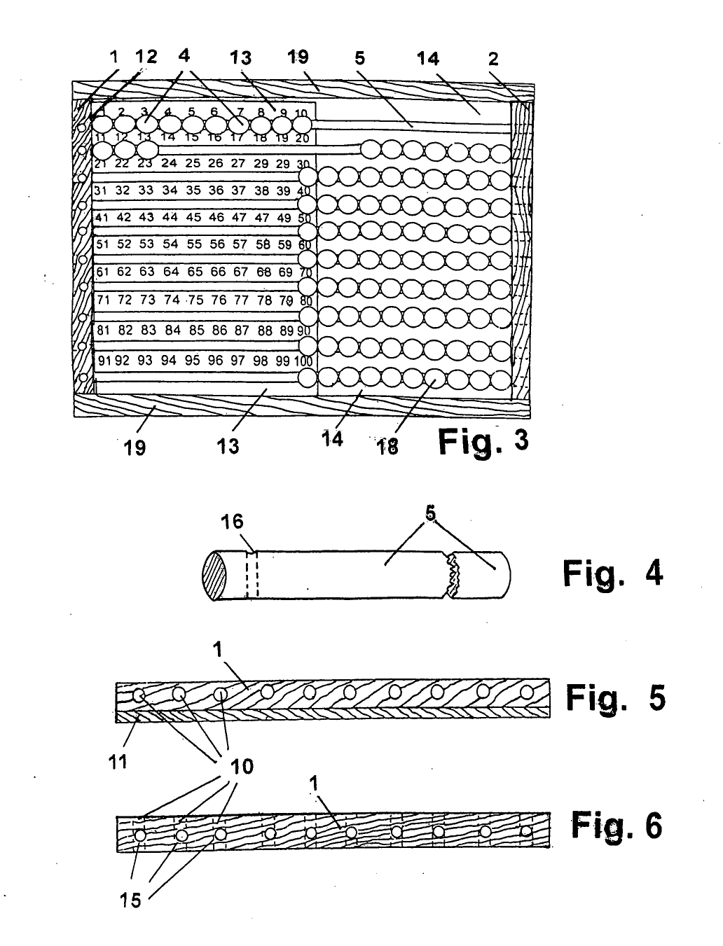

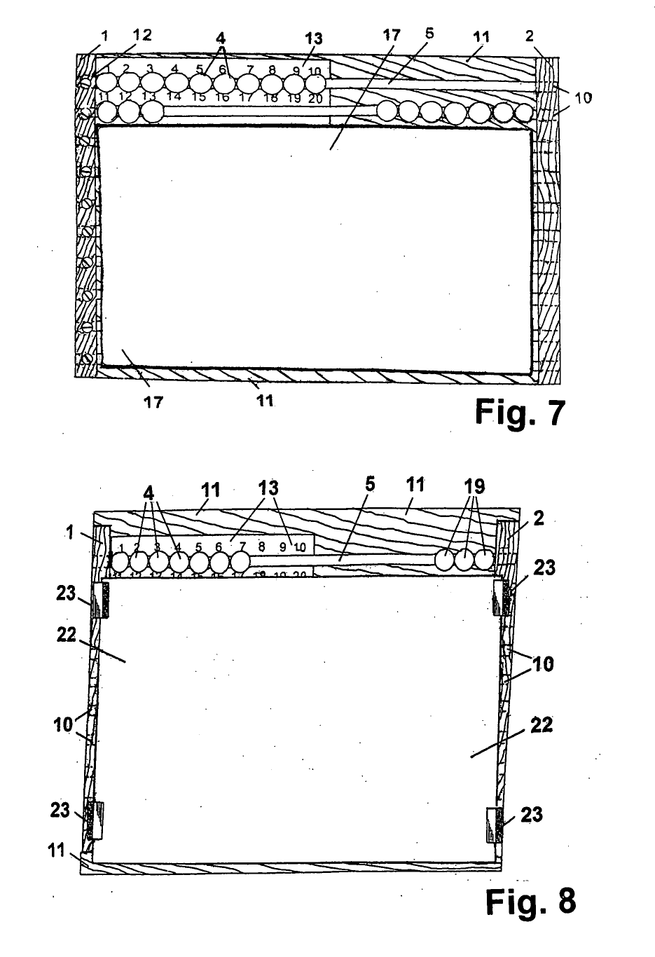

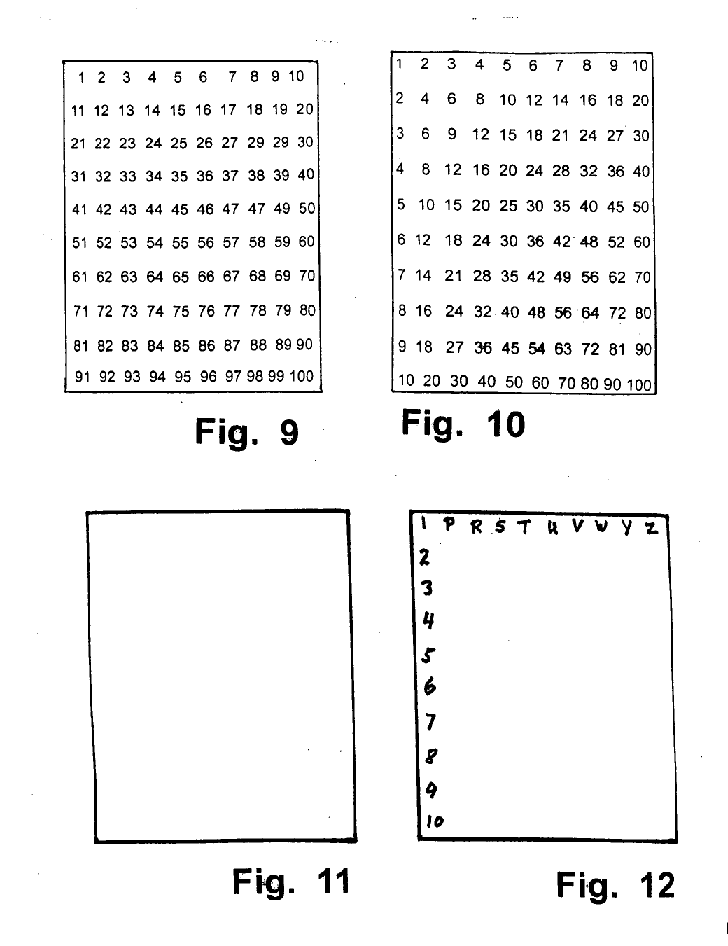

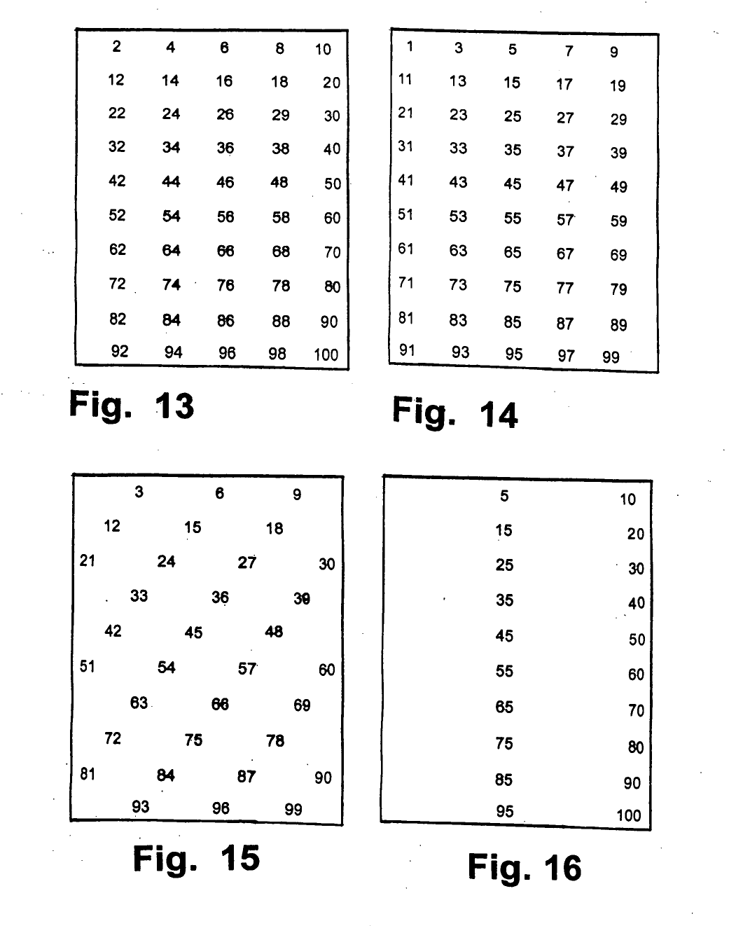

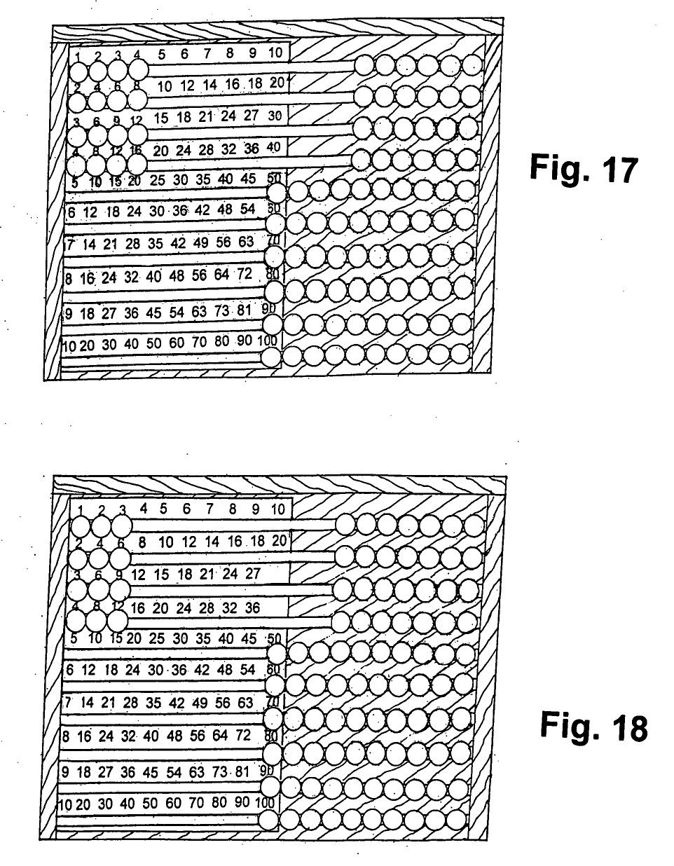

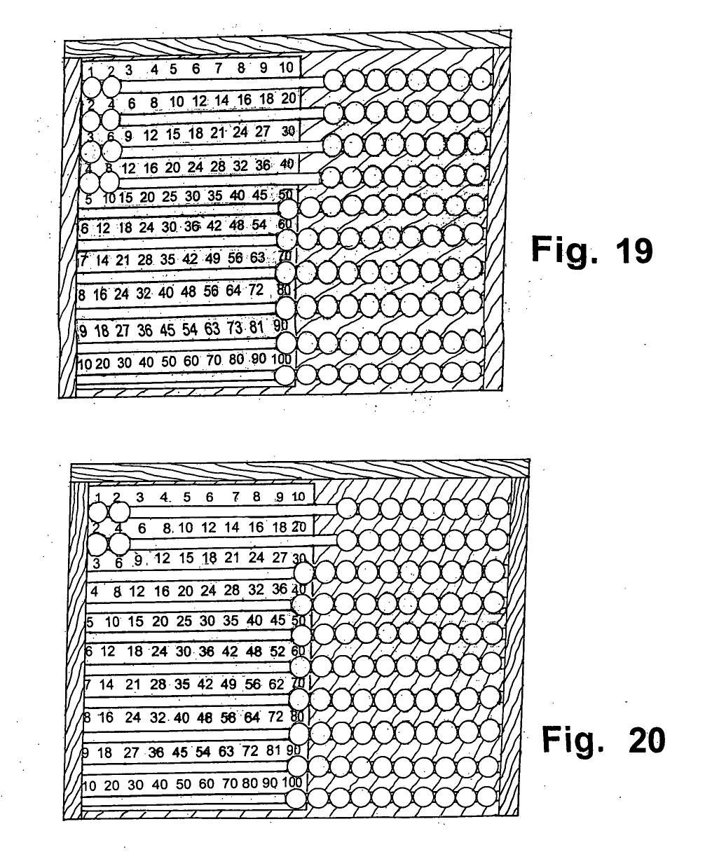

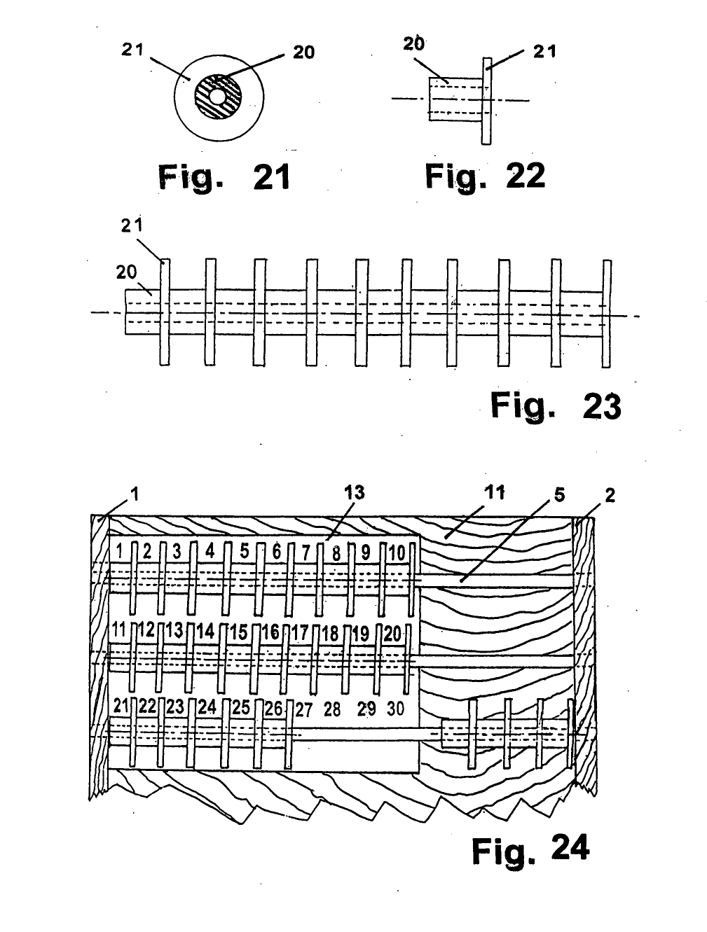

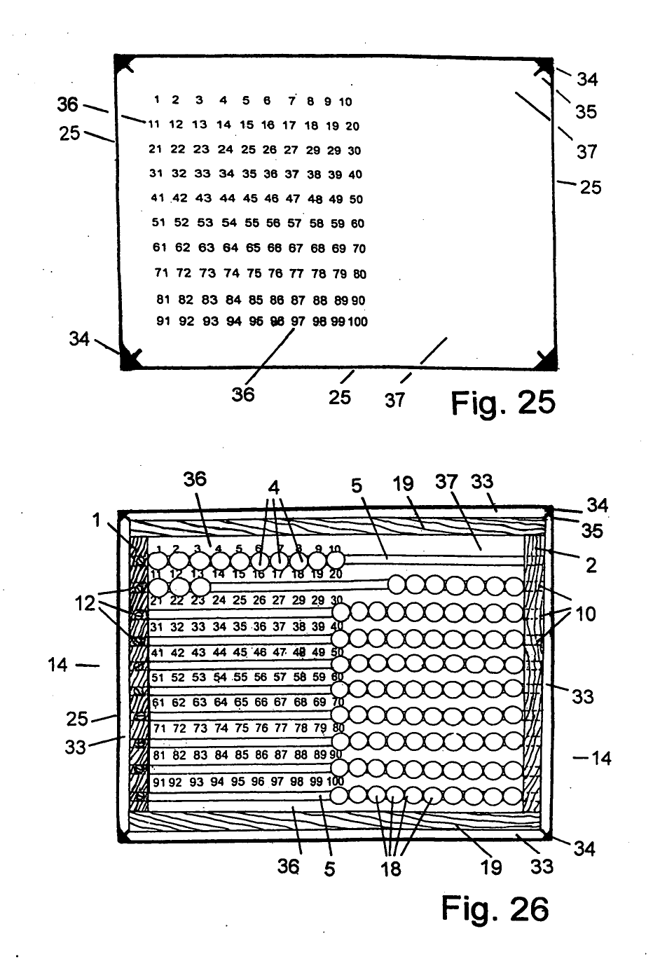

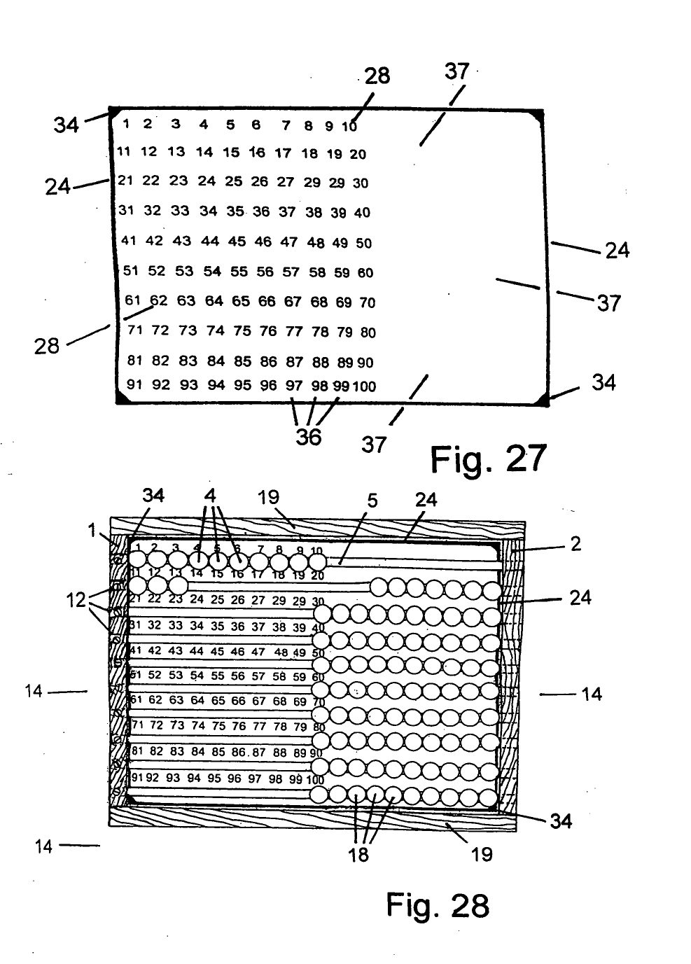

In FIG. 1. bead # 6 has a value of ten when it is pushed against counter bar # 1, But bead-# 6 has no value when it is pushed against non-counter bar # 3.

On the second rod, each of ten beads # 7, has a value of ten per bead, when it or its neighbor is pushed against counting bar # 1. And these ten beads # 7, have no value when they are pressed against non-counter bar # 2.

The single bead on the second rod has a value of 100 when it is pushed against counter bar # 1; and it has no value when it is pushed against non-counter bar # 3.

On the third rod are ten beads # 8, that are given a value of 100 each when they are pushed against counter bar # 1. And these same beads are given no value when they or their touching neighbors are pushed against non-counter bar # 2. And on the third rod, on the left side is a single bead. And this single bead on the left side of the abacus has a value of 1000 when it touches counter bar # 1; and it has no value when it touches non-counter bar # 3.

And on the fourth rod are ten beads # 9, that have a value of 1000 each when they, or their touching neighboring beads touch counting bar # 1. But beads # 9 have no value when they or their touching neighbors are touching non-counter bar # 2.

On the fourth rod, on the left hand side is a single bead. And this single bead has a value of 10,000 when it is touching counter bar # 1; and this single bead has no value when it is touching non-counter bar # 3.

And in this typical commercial abacus, the usual pattern of use is to substitute ten counting beads (# 4) on the right that are touching the counter bar for one bead (# 6) on the left that is touching the counter bar. And ten beads (# 4) on on the first rod with a value of one each, may also be exchanged for one bead (# 7), on the second rod that has a value of ten. And this pattern of ten to one exchange persists for the beads on the second, third, and fourth rods

And FIG. 2, is the preferred image for this invention. And FIG. 2 is a drawing of a simple abacus, where each of ten rods has ten beads on each rod. And on this simple abacus, all beads have a value of one, when that bead, or when that group of beads touch the counter bar. And this simple type of abacus is most commonly used to help beginning learners, learn their numbers from one to one hundred, by learning to count the series of beads on ten rods (or fewer) where there are ten beads per rod. And this simple abacus is also used to help beginners learn simple addition and simple subtraction.

And in FIG. 2, the left hand edge piece (# 1) is the counter bar. And the right hand edge piece (# 2) is the non-counter bar. And # 4 are single beads in the counting area that are pushed against the counter bar (# 1), and this makes each of these beads have a value of one each; for a sum of ten for each full row of beads, where all beads are pressed against the counter bar. And in this simple abacus, this also this gives a value of one each for each bead that touches the counter bar—when there are fewer than ten beads that are pressed against the counter bar. In this simple abacus, as a rule, the student must have all of the beads in the higher rows of beads pressed against the counter bar before, the student user can use to the beads on the lower rods. And unused beads are left in the non-counter area pressed against the non-counter bar. (#2)

And on the second rod (# 5 is used to indicate all rods), there are three beads pressed against the counter bar (# 1) with a value of one each. And on the second rod, there are seven beads pushed against the non-counter bar (# 2), which at this moment have no value. Thus the total value of the beads on rods one and two in FIG. 2, add up to thirteen.

And in FIG. 2, the number 10, is used for the dotted lines to show the locations of the top three horizontal holes in the right hand edge piece that keep the horizontal rods in position. And similar horizontal dotted lines are used to show the locations of other horizontal holes that keep other rods in position in the left and right edge pieces.

And in FIG. 2, the number 11, is used to indicate a small sheet of plywood that lies under the ten rods with their sets of ten beads per rod. And this sheet of plywood (# 11) is glued and stapled to the bottom of edge pieces # 1 and # 2 (which also act as the counter bar and the non-counter bar.) And sheet of plywood #11, is used to give strength to the frame of this simple abacus, and also is used to provide bottom support for printed grids of numbers (# 13) or for blank sheets of numbers which are to be positioned on this flat bottom piece. (# 11). (See FIG. 11, for Blank Sheets of numbers.)

And # 12. in FIG. 2 indicates the head of a wood screw that is used to hold the ten rods in proper position within the ten sets of holes in the two side edge pieces indicated by # 10 in FIGS. 2 and 3.

And in FIG. 2, # 13 shows a printed grid of numbers which has been placed under the rows of beads that are given value. And this printed grid of numbers can be temporarily taped to the plywood floor of this simple abacus (as in FIG. 2). And this grid of numbers (# 13) is the primary “augmentation” of this invention. And it is the use of this type of augmentation which I believe is different from previously existing simple abacuses.

And # 13 is a printed grid of numbers, where when the beads on the rods are all pressed against the counter bar (#1); all of the beads in the counter area will then show or exhibit the printed number of that bead, above that bead.

And # 18 is to indicate the “non-counter beads” (of which there are eighty seven) in FIG. 2, that are pressed against the non-counter bar (# 2).

FIG. 3 shows a different type of construction for this simple abacus, where there is no plywood bottom, and actually there is no bottom at all. However augmentation sheets of several types can be used with this type of abacus, by placing a sheet on a flat surface, such as table top, or a desk top. And the augmentation sheet can be placed on this desk top or table top directly under the rods that contain ten beads per rod in the counting area, And these beads become counters when they contact the contact the counting bar (# 1).

FIG. 3, is similar to FIG. 2, except: 1.) it had no permanent hard bottom surface; and 2.) its construction is primarily a frame of four wooden parts, plus ten rods. The left and right edge pieces are pretty much the same as in FIG. 2. But in FIG. 3, a top wooden part (# 19) and a bottom wooden part (# 19) are major parts of the construction of this frame.

And the simple abacus shown in FIG. 3 can be used with printed sheets of augmentations, when these sheets are precisely located on a desk top or on a table top; and the frame of this abacus is properly located above this printed grid of numbers. A major problem with a frame in this type of abacus is that it may be easily broken. by pounding one corner on the floor, or on a hard object. Then when it is broken, the beads are likely to be released And if the beads are small; these beads can present the risk of their being taken into the mouths of small children, and sometimes sucked into their throats and lungs.

Number 13 shown in FIG. 3, is a printed grid of numbers that can be placed below the ten beads per rod, when these ten beads are pushed against the left edge piece (the counter bar). And if this abacus is over a flat desk top or a flat table, either of these can provide the support for the augmentation sheet.

In FIG. 3, number 14 indicates a solid surface below the frame of this simple abacus, on which a grid of numbers can be located, as is illustrated in FIG. 3

In FIG. 3, the number 18 shows ten beads per rod on the lower eight rods of beads that are non-counters

FIG. 3 also shows the heads of ten wood screws (# 12), that can be removed, And removing these screws permit's the individual rods with ten beads per rod, to be removed from the abacus frame. And for beginners, this removal of eight or nine rods and eighty or ninety beads, may cause less confusion; as they have fewer items to contend with in learning to count and in learning simple addition and subtraction.

FIG. 4, shows a rod (# 5) with a small diameter hole (# 16) drilled through the rod, near the left end. This small hole is so that a wood screw or similar screw can be placed through this hole while this rod is in the frame, so that each rod can be secured in position within the frame, and also removed later if this is desired.

FIG. 5 is a side view of the left and right side edge pieces that have been glued and/or stapled to an underlying sheet of plywood, (# 11) or similar material. And FIG. 5 also shows ten parallel holes through an edge piece. And these ten holes are to provide the locations for each of the ten rods that are secured within the frame of the simple abacus. And each of these ten rods is to carry ten beads that are movable in a lateral direction. Thus each bead can be shifted from the left side to the right side and back as the needs may indicate.

FIG. 6, is a top view of the left hand edge piece (# 1). And this top view shows the ten vertical holes (15) that are the sites for placement of the wood screws to secure the wooden rods within this left edge piece.

FIG. 7 indicates two temporary changes that have been made in the abacus as Is shown in FIG. 2; The first change is that the bottom eight rods with their ten beads per rod have been removed; such as by taking out one wood screw per rod, and then pushing the rod out of its two holes in the two side pieces. The second change is then to position a large sheet of blank paper over the eight lower rows of numbers in the printed grid of numbers. The purpose of this large blank sheet (# 17) is to cover the numbers that are not yet needed. This may help lessen the amount of information and confusion that some beginning learners have to contend with in their attempts at learning to count small numbers, and also in their attempts at learning addition and subtraction.

FIG. 8 is similar to FIG. 7, except that the large sheet of blank paper or plastic has been moved to a position above the lower nine rows of beads and above the nine rows of rods, which are left in place. And the lateral edges of this large blank sheet are taped to the tops of left and right edge pieces.

FIG. 9, is a printed sheet of numbers, printed on a grid, of a type that has been designed to work with this simple abacus to help young beginning learners learn to count. And young learners are to first learn to count and to identify the numbers from one through ten. And children are to then learn progressively larger numbers; ten numbers at a time. And also at the same time the beginning learner is learning to count; they can get to see in action the functions of addition and subtraction; as one or more beads are added to the group of “counters”; or as one or more beads are taken away from the group of counters, and moved into the “non-counter area”.

FIG. 10, is also a printed sheet of numbers, arranged in a grid pattern that is to be placed beneath the rods and beads in the “counter area” However this pattern of numbers is different from the pattern of numbers in FIG. 9. This second pattern of numbers in a grid is to help slightly advanced learners learn the multiplication tables and learn multiplication, division, and get the idea of what fractions are about. And the numbers in this augmentation are the “products” of two numbers of ten or under that are multiplied together. And the design of this grid of numbers is to have numbers from #1 (at the top) to #10 at the bottom in a column of ten numbers along the left hand edge of this grid of numbers. And to also have the top row of printed numbers to start at number # 1 in the upper left hand corner, and proceed in a sequence to number to # 10 at the far right edge of the top row in this printed grid of numbers.

And in FIG. 10, the other rows and columns of numbers in this grid of numbers are the “products” of the “multiplier” (one of the ten numbers in the left hand column) and the “multiplicand” (one of the numbers from # 1 to # 10 in the top row of numbers.) And with this arrangement, a “product” is the result of a “multiplier number”, intersecting with a “multiplicand number” to produce a product.

And with this second type of grid of printed numbers, the young learner should learn to set aside the “rule”, that all of the top rows of beads should be fully in contact with the counter bar, on the left side of the simple abacus to be actually counted. “This second grid of numbers is a “different ball game”, with a “different set of rules”. And in this “different ball game” what is looked for are the building of “squares of beads”, and the building of “rectangles of beads”.

And the rule for building a square of beads, and also a building rectangle of beads is that the left column of beads always starts with the top bead (#1), and may extend to any number below this #1 bead. And the top row of beads always starts at the left hand (#1) bead, and may extend to any number of bead to the right of this #1 bead. And in this “game of multiplicand times multiplier”; their “product” always appears as the printed number at the intersection of this multiplicand and multiplier, in the lower right hand corner of the square or rectangle of beads formed by the beads in this particular set of multiplier and multiplicand.

And the desired result of playing games with these squares and rectangles made up of columns of beads times rows of beads is to gain a concrete understanding of the multiplication tables. And the squares and rectangles of various sizes and shapes are the result of the different combinations of two numbers (of ten and under) that are used in the multiplication tables. And by the use of this simple augmented abacus with the grid of numbers in FIG. 10, the user can also gain some awareness of the processes of multiplication and division, and also fractions. And this is done by dividing these rectangles and squares along the lines between the rows of beads; and also, dividing along the lines between the columns of beads. See FIGS. 17 18, 19, and 20 for an illustration of this.

And FIG. 11 is a blank sheet. And this blank sheet is to be placed under the rods and beads on the left hand side of the simple abacus. And this blank sheet can be used in several ways. And one way is to have the user write in the numbers of the beads as he is positioning them in the counting area. And this can be done with both types of number grids described previously. It has been found in learning and in remembering that we learn better and remember better when we write down what we have learned. This additional action of writing involves more parts of our brain's sensory-motor systems. And this greater brain involvement enhances our memory for that information. And this blank sheet can be used by the tutor or mentor as a way to set up other types of learning about numbers, such as in FIG. 12.

FIG. 12 is a blank sheet that has been partly filled in by another person to help young learners comprehend equations with one unknown number. And this blank sheet now has written numbers along the left side, in a column from one at the top to ten at the bottom of the column. And in FIG. 12, number one is retained in the far left position in the top row. However other positions in the top row have been filled by letter symbols (not numbers). And in building a square or rectangle of beads, the number of beads that are to be used from a column is chosen first. Then the user picks out a letter symbol from the top row to be their “unknown number”. And the user then fills in the square or rectangle of beads using the number from the column, and the letter symbol from the top row as the axes of that square or rectangle. And after the square or rectangle of beads is built, the user looks at the lower right hand bead in this square or rectangle to get the number “product” of this number times this letter symbol. And a teacher and some parents can then show the learner how to set up an equation with one unknown number. And for example, the “product number” is: 48. And the column multiplier is number 8. And the multiplicand number-symbol is: V. And the student user is shown that 8 times V equals 48. And this can be written as: 8 times V=48; or as: 8×V=48. And now please solve for the number value of V. And this is done by dividing both sides of the equation (both sides of the equals sign) by the number 8. And the user is told the math rule that: “Equals divided by equals are equal”. And this means that the user can divide both numbers on each side of the equals sign by the same number (eight). And eight divided into 48 gives us 6. So, V=6. And similar equations can be set up in the same way. Thus the student is given a concrete experience in which to learn about equations with one unknown number, And in learning, it is always best to have concrete experiences about concepts before we are expected to master similar abstract experiences.

FIG. 13 is an augmentation for a simple abacus that helps a young learner learn how to count to # 100 by twos; and also helps the young learner learn the multiplication tables of two times numbers from # 1 to # 10, (where the products are #2 to #20).

FIG. 14 is counting to 99 by the use of the “odd numbers” from # 1 to # 100. And the “odd numbers” are easily seen and recognized in FIG. 14.

FIG. 15 is to help the young learner count from one to 99 by “threes”. And FIG. 15 also introduces the idea of the multiplication tables, where # 3 is multiplied by other numbers from one to ten, and beyond.

FIG. 16 introduces the multiplication tables of # 5, and # 10, with numbers extending to # 100. And in a similar manner, the other multiplication tables of: the fours; the sixes; the sevens; the eights; and the nines; can be introduced in this manner, of having them printed on an augmentation to place under the “counter part’ of a simple abacus.

FIG. 17 is a “cut-away” view of the left hand corner of the type of abacus seen in FIG. 2, with a plywood bottom, # 11, and also with a top wooden frame piece, # 19. And one additional change between FIG. 2. and FIG. 17, is that on the plywood surface of FIG. 17, is the type of printed grid of numbers seen in FIG. 10. And FIG. 17, shows “counter beads”, # 4, where each column has four beads. And there are four such columns in the counter area. And if one looks closely at the lowest row of beads; above the fourth bead on the on the right, is the number 16. And this illustrates in a concrete way, that a group of beads that are four beads high and four beads wide contains 16 beads Thus the “product” of four time four is 16. And this illustrates one of the multiplication tables in a very concrete way for the beginning learner. And other “products” of two numbers of ten or under can be demonstrated in the same way. And beginning learners playing or working with this simple abacus that is augmented with this particular printed grid (shown in FIG. 10), can be helped to see and work with the multiplication tables in a concrete way.

FIG. 18, is very similar to FIG. 17, except that there are only three columns of beads that are four beads high. And if one looks above the third bead on the lowest row of beads, you can see the number 12. And this illustrates in a concrete way that the “product” of four and three when multiplied together gives you 12.

FIG. 19, is similar to FIGS. 17, and 18. And in FIG. 19, there are only two columns of beads that are four beads high. And if you look above the lowest bead in the second column, you will find the printed the number 8. And this shows in a concrete way that the “product” of four and two, when multiplied together, gives you the number 8 And with sufficient practice, with this simple abacus, that has an augmentation to help learn the multiplication tables; these multiplication tables can become more easily remembered over a span of time. And young learners learn best when they are presented with information that they can comprehend in a concrete way, and then practice and drill with this material.

FIG. 20, is similar to FIGS. 17, 18, and 19, except that there are only four beads illustrated in FIG. 20. And these four beads are two beads per column, and these beads are two columns wide. And if we look above the lowest bead on the right, we can see the number 4. And this 4, is the “product” of two times two, And again this illustrates the multiplication tables in a concrete way. But it Is possible for the mentor or parent to ask the child to divide the 8 beads in FIG. 19, into two equal parts, and push the lower part into the “non-counter area”. And then see what this leaves you with. Thus the idea of simple division can be introduced by working with these beads on a simple abacus with the augmentation shown in FIG. 10, placed on the bottom of the counting area.

FIG. 21, is a “front on” view of a type of bead, that is composed of two parts. One part is given the # 20, and this part is a tube like part. The second part is a disk like part, and it is given the number 21. In practical terms both parts can be molded as a single part, at the same time, in a plastic injection mold.

FIG. 22, is both a top view and a side view of this two part molded bead; where # 20 is the tube like part; and where # 21 is the disk like part.

FIG. 23, shows a drawing of ten of these disk like parts pressed together along a common axis (such as being on a rod like structure.) And the first disk on the left in this group of ten of these beads has the same numbers as are on the single part shown in FIGS. 21 and 22.

FIG. 24, shows three of these groups of a rod plus ten disk like parts in position on a simple augmented abacus which contains a printed grid of a type shown in FIG. 9. And the numbers: 1, 13, 11, 5, and 2 in FIG. 23, correspond to the numbers seen in the type of abacus shown in FIG. 2. And FIG. 24 shows the purpose of this odd shaped disk that has a rod shape combined with a disk shape And the purpose is to help the printed numbers on the underlying grid of numbers (# 13) be more easily viewed, and less obstructed by the beads in the counter area. And it is my belief that this will allow a “safe simple abacus” to be constructed that can be of smaller size than if oval or sphere shaped beads are used as counters and non-counters on a rod, wire, or rope.

FIG. 25 is a larger size augmentation that contains a grid of numbers from one to one hundred. This larger size augmentation is to be placed on a flat desk top or a table top. And a simple abacus like the one in FIG. 3, (without a bottom) is to be positioned on top of this larger augmentation. And the four outer margins, #25 will be located outside of the outer edges of the frame of the abacus shown in FIG. 3. And the four corners of this augmentation are printed in dark triangles # 34, that have extensions # 35 heading inward from these dark triangles. And the purpose of # 34 and # 35 are to help properly locate the abacus shown in FIG. 3 accurately over this type of augmentation. And # 36 indicates the grid of numbers in the counter area. And # 37 indicates the large unprinted space in this augmentation. And FIG. 26 shows how this combination works together.

FIG. 26 shows how the abacus in FIG. 3 can be accurately located over this larger size augmentation shown in FIG. 25, when this augmentation is on a flat surface such as a table top or a desk top. And the numbers below #19 seen in FIG. 26 are the same as the numbers as are used in FIG. 3. And numbers: # 25, # 34, # 35, # 36, and # 37 are the same as these numbers used in FIG. 25. And # 33 in FIG. 26 shows the space on the augmentation in FIG. 25 that exists outside of the outer rim of the frame of simple abacus used in this arrangement.

FIG. 27 is a slightly smaller version of FIG. 25, that is mostly similar in other respects. However in FIG. 27, the slightly smaller margins are given # 24. And corner markings # 35 are not present. The purpose of the augmentation shown in FIG. 27, is to be located within the inner margins of the frame of the simple abacus shown in FIG. 3. And the four dark corners, # 34, are to be located within the frame of the abacus shown in FIG. 3. And the augmentation in shown In FIG. 27 is to be located on a flat surface, such as a table top or a desk top.

FIG. 28 shows the augmentation in FIG. 27 located within the wooden rectangular frame of the simple abacus shown in FIG. 3. And the numbers of parts # 19, and under are the same as are shown in FIG. 3. And # 14 is the flat surface of a table top or a desk top; on which the augmentation from FIG. 27, and the simple abacus from FIG. 3 are located. And # 34 shows the four dark triangular corners located within the inner corners of the frame of the abacus shown in FIG. 3. And # 24 shows the outer dark outer edge of the augmentation illustrated in FIG. 27.

### DETAILED DESCRIPTION OF THE INVENTION

### Plus Some Information on My Patent Search

Much of the detail of this invention is presented in the previous sections, such as: Background; Brief Summary of the Invention; and Brief Description of the Drawings. Thus the following is more of an overview, and information about my search of the prior art.

The basic concept or innovation of this invention is a tool to help very young children learn the numbers from one to ten, and then from one to one hundred. And this tool can also help young children learn to add and subtract small numbers. This tool is an augmentation to a simple abacus. And this augmentation is to add one or more additional parts to a simple abacus. And the first additional part is composed of a printed or written sheet of paper or plastic that contains a grid of printed or written numbers. And this grid of numbers is accurately positioned beneath the rows of ten beads on a simple abacus—when these ten (or fewer) “counter beads” are pressed against the “counter bar”. This “counter bar” is the left side edge piece of this simple abacus. And in this simple abacus, all beads in all rows have a value of one, when that bead, or one of its touching neighbor beads, are touching the counter bar of that simple abacus. And in this simple augmented abacus, all beads have a potential value of one each. And this potential value of one is “made real”, when that bead, or one of its touching neighbors, is pressed against the counter bar.

And all beads on all rows that are not touching the counter bar, or are not touching neighboring beads that are touching the counter bar are considered as “non-counters” and should be pushed against the “non-counter bar” which in this invention is the right edge piece.

And this printed sheet is an augmentation that is a grid of numbers, that go from one to one hundred, with ten successive numbers being beneath beads on the ten rods or ten segments of rope that substitute for rods or wires. And this type of augmentation to a simple abacus is to help young learners, to learn to count numbers in a sequence first from one to ten; then from one to twenty, and then from # 1 to # 100. And this sequence of printed numbers is broken down into ten rows of printed numbers, one row above another; where each row has ten consecutive numbers in it; in a left to right direction. And this printed grid of numbers is designed or “laid out” so that each bead in this abacus that contains ten rows of beads from top to bottom has ten beads per row. And where when all 100 beads are pushed against the left hand edge piece (the counting bar), and the number of each bead in a # 1 to # 100 sequence; will appear on this printed grid above (or below) each bead. And this printed or hand written grid of numbers is positioned beneath the ten rows of ten beads per row. This simple abacus is designed with a viewing space between each row of beads to see the numbers on the printed or hand written grid that is beneath these ten rows of beads.

And in this first variation of this printed grid of numbers are printed numbers that show the number of each bead in a sequence from #1 to # 100. And this sequence of numbers that are beneath the rows of beads appear in the spaces between the rows of beads; when: 1.) this grid is properly positioned beneath the “counter beads”; and 2.) when these counter beads or their touching neighboring beads are all pressed against the left edge “counter bar”.

And this simple abacus is laid out with ten rows of beads, with ten beads per row; where the top row is first. And rows two through ten are located in a sequence below this top row of ten beads. And to make this grid of numbers from one to ten on the first row; and then from number eleven through number twenty on the second row (with rows three through ten following in this pattern); work properly; this grid has to be positioned properly beneath the beads that are touching the counter bar on the left edge of the abacus. And beads that are given no value are pushed against the “non-counter bar” on the right edge of this simple abacus. (The paragraphs: # 127, # 128, #129 and # 139 describe the first variation of an augmentation for this simple abacus in more detail.)

And the other variations of this augmentation have many similar features to those features described for this first variation.

Shown in FIGS. 9, 10, 11, 12, 13, 14, 15, and 16 are eight types of augmentations that are a part of this innovation or invention. And five additional variations that help a learner with the multiplication tables for the numbers: 4, 6, 7, 8, and 9, are described in paragraph # [0077] under: BRIEF SUMMARY OF THE INVENTION. And paragraphs: [0108] and [0109], describe the first four types of augmentations or Innovations, as do paragraphs: 127, 128, 129, 130, 131, 132, 133, 134, 135, and 136. And for this first type of innovation to work properly in all of the rows above the lowest row that has beads on it, in the counter area, the previous rows of ten beads, have to be filled with ten beads per row, where each bead and/or its neighbor has to be pressing against the counter bar. This type of augmentation is illustrated in FIGS. 2, 3, and 9.

A second type of printed augmentation is shown in FIG. 10. In this second type of augmentation, a printed sheet of paper or plastic; has ten columns of numbers that represent the “products” of the multiplication tables, with the “ones” in the left column And the “twos” are in the second column—to the right of the first column. And the “threes” are shown in the third column. And the “fours” are shown in the fourth column. And the “fives” are shown in the fifth column, And the “sixes” are shown in the sixth column. And the “sevens” are in the seventh column. And the “eights” are in the eighth column. And the “nines” are in the ninth column. And the “tens” are in the tenth column.

And with the augmentation that is shown in FIG. 10, the rules change. In augmentation # 10, the goals of this second type of augmentation are to: 1.) help children learn the multiplication tables; 2.) to help children learn how to multiply two numbers that have a value of ten or less; and 3.) to learn something about dividing numbers of ten or less into other larger numbers that are under one hundred. And FIGS. 17, 18, 19, and 20; illustrate how the beads on rods can be used to build squares and rectangles of beads that represent the “products” of a multiplier (the height of the column in beads) and the multiplicand (the width of the rows in beads). And the “product” of a multiplier (of 10 or under), when multiplied with a multiplicand (of 10 or under) always appears as a number slightly above the lowest bead on the right in that square or rectangle of beads.

And a blank sheet as is illustrated in FIG. 11, that is placed under the group of “counter beads” can be used as an augmentation to a simple abacus in several ways, which include:
1.) beginning learners can write in the numbers of each bead, as they move one or more beads into the counting area, where these beads touch the counter bar, or touch other beads that are in contact with the counter bar;
2.) the parent, teacher, or tutor can write in part of the numbers on a grid of beads, and then have the beginning learner then write in the remaining numbers;
And 3.) the teacher or mentor can then write in the numbers as seen in the first column of beads on the left in FIG. 10; and then substitute letter symbols or other symbols for the numbers 2 through 10 in the top row of beads. This can be useful for helping children learn how to figure out an equation with one unknown number. (Refer to FIG. 12 to see this.)

And in a parent or teacher prepared augmentation sheet as is illustrated in FIG. 12, this sheet can be used to help moderately advanced learners learn how to solve equations with one unknown number.

And FIGS. 21, 22, 23, and 24; are used to illustrate a type of bead that can be used on a simple abacus, to show more of the printed numbers on a grid that is placed beneath the rows of counter beads on a simple abacus.

My searches to find if anyone else had previously used or patented augmentations to go with an abacus involved five main areas, (listed below)
1.) I visited three toy stores, one of giant size. And the giant sized toy store had five types or sizes of abacuses, but none had an augmentation similar to the types of augmentations I am covering in this patent application.
2.) I searched several e-mail search services with the words: abacus, teaching, and arithmetic. And though I found a number of web sites about abacuses, none mentioned anything like my current augmentations to a simple abacus.
3.) I visited Linda Hall Library several times, and used its search engines, and received help from their personnel about conducting a search using their data bases. And I also read parts of two books they had on abacuses. These books are: 1.) History of the Abacus, by J, M, Pullan, published in 1968 by Hutchinson, London and New York: and 2.) The Abacus; Its History, Its Design; Its Possibilities in the Modern World, by Parry Moon of M.I. T., published in 1971, by: Gordon and Breach, Science Publishers. New York and London. And these books contained much interesting information, but nothing that resembled my augmentations to a simple abacus.
4.) And I visited the Library and Resource Center in the Education Building at the University of Missouri at Kansas City, and talked with their supervising librarian about my interest in the current use of abacuses in elementary or pre-school education. And she looked this up in several ways in her data bases, and found nothing about abacuses, and their currently being used as teaching materials in current elementary education programs.

And I then went to the main library of the University of Missouri at Kansas City and requested the help of one of their librarians in looking up information about abacuses, and their use in education. And she found a number of journal articles of a scientific nature (in journals they did not have). But she also located four books in their library. And one of these four books was checked out. And two of these books were the same books I had obtained at Linda Hall Library, and had partly read. But she found a fourth book that has a chapter on abacuses that was of recent printing. This book has the title of: Tools of American Mathematics in Teaching: 1800 to 2000. And it has three authors: P. G. Kidwell, A. A. Hastings, and D. L. Roberts. And it was published in 2008 by John Hopkins Press. And chapter 6, has the heading: “The Abacus-Palpable Arithmetic.” And it noted a decline in the use of the abacus as a teaching tool in the USA. And this chapter also noted that the abacus was introduced into US elementary schools from France and Great Britain between 1820 and 1830. And this chapter on abacuses noted that most often the abacus was used in “infant schools” (for children from one year through six years of age.) And this book and the two books previously noted, covered a wide variety of types of abacuses used in past and some types that are still in current use. But in my searches I was unable to find anything similar to my current augmentations that are or have been used with an abacus.

From the three books about abacuses mentioned above, it appears that the Russian Abacus was used as a model of the simple type of abacus that has been used in the USA since the 1820's to help children learn to count and to learn to add and subtract small numbers. In the book noted in paragraph [0143] above, it notes that two soldiers from Napoleon's army returned to France from Russia with knowledge of the Russian Abacus, and introduced this type of abacus into French infant schools and French elementary schools in the early 1800's. And the Russian Abacus is very similar to the simple abacus described in this patent application. It uses horizontal wires or rods, with ten beads per rod.

1. is to make an abacus more useful by adding augmentations to help children learn: to count numbers; to learn simple addition and subtraction and to also learn: the multiplication tables; multiplication and division. And this is done by the use of several types of printed or hand written augmentations (additional parts that are added to a simple abacus); where these augmentations are a sheet that is printed or hand written; and is to be placed beneath the beads in an abacus that are in the “counter area”, and are touching the counter bar. And on this printed or hand written augmentation sheet are a grid of numbers; or other written information where the numbers (or symbols) on this grid are positioned so that when the beads in the rows of beads are in the counter area; the number of each bead, in that sequence of beads, from: # 1 to # 100, (or less—or more), appears in the grid of numbers, either slightly above or slightly below the rows of beads; when all of the beads in all of the rows are touching the counter bar, or are touching neighboring beads; one of which is touching the counter bar. The terms (or less—or more), means that a similar abacus can be built, with only: ten; twenty, thirty, forty, fifty, sixty, seventy, eighty, ninety, or possibly one hundred and ten beads, or one hundred and twenty beads, or more beads. And the numbers (or symbols) on an augmentation, are assigned to each bead. And each number or symbol appears in the space between the rows of beads above (or below) the bead to which that number has been assigned. And this assigned number or symbol appears in its proper relationship with its bead only when that bead and the previous “counter beads” in that sequence or series of beads have been properly positioned by their being pressed against the counter bar.

2. is an extension of claim 1. (Background: A simple abacus has ten beads per row, and each bead usually has a value of one, when that bead, or its touching neighbor beads are pushed against the counter bar. And a bead has no value when it is pushed away from the counter bar, and it is pushed against the “non-counter bar”.) Claim 1 is about the use of augmentations that are to be positioned beneath the rows of beads in a simple abacus, and different patterns of augmentations can be used in a variety of ways that are partly described in claim I. (For different types or different patterns of augmentations see: FIGS. 7, 8, 9, 10, 11, 12, 13, 14, 15, 16, 25, & 27.) In claim 2, I am claiming the use of a standard frame with no bottom, where these printed or hand written augmentations (of two sizes) are placed (one at a time) on a flat surface that is beneath this simple abacus that does not have a bottom. (See FIG. 3.) And where this simple abacus is positioned over (or above) an augmentation, where this augmentation has been painted on this flat surface, or has been previously printed or hand written on a sheet, and then positioned on this flat surface (table top or desk top); so that the grid of numbers or other printed or hand written information can be viewed by looking between the rows of beads when these single beads, or groups of beads are pressed against the counting bar. And for the numbers on the lower rows of this grid to be accurate, the beads above this lower row must include ten beads per row where they or their neighboring beads are touching the counter bar. And when this is properly done, each bead will have its assigned number or symbol appear above (or below) that bead, when that bead or one of its touching neighbor beads is pressed against the counting bar.

3. is similar to the simple abacus described in claims # 1 and # 2, but this simple abacus has a flat bottom surface that extends under all of the rods or ropes and under all of the beads regardless of their location on the rods or segments. And this flat bottom surface may be temporary or permanent. When the flat bottom surface is temporary, this flat bottom surface is detachable, and may be reattached when this is desired, or needed. (This would be like FIG. 3, but where a sheet of hard board or plywood could be attached to, or removed from the bottom of the frame in FIG. 3.) When the flat bottom surface is permanent, this flat bottom surface is an integral part of the abacus, and extends under all of the rods (or segments of rope or wire) and also extends under the left edge piece and the right edge piece. And this bottom piece may be attached to other (top and bottom) edge pieces. This flat bottom surface makes it easier for the parent, tutor, or teacher to attach one of the several types of augmentation sheets on its proper flat bottom location beneath the beads when they, or their touching neighbors, touch the left edge piece. And pieces of removable tape, or other material may be used to secure each augmentation in its proper position. And the tutor or student may then to be able to remove one augmentation, and replace it with a different augmentation to fulfill a different teaching and learning task or function. Thus one simple abacus may be used in a number of different ways, by using several different types of augmentation sheets; that are used to help teach a number of different math or arithmetic concepts. One of the concepts about learning new tasks or skills is that we learn best by “doing”, or working or playing with the materials, in an active physical way. And a simple abacus with a variety of printed or hand written augmentations provides one way for this active physical involvement type of learning experience to occur.

4. is to construct a simple abacus so that the rods and the beads can be easily removed from the abacus; and easily replaced. This permit's the parent, tutor or teacher to start with only one rod and its ten beads. Or the tutor can start with an equivalent segment of rope that contains ten beads; that can be used in place of one rod that contains ten beads. The reason for starting with only one rod or one segment of rope, is so that the young learner is not over whelmed by one hundred beads in the counting area on ten rods, which lie over one hundred printed numbers, at the start of learning to count with an augmented simple abacus. And after the young learner has mastered the numbers from one through ten, the parent or tutor can add a second rod and ten beads, or can add a second segment of rope with ten beads. And this then gives the beginning learner twenty beads to work with. And FIGS. 2, 3, 4, 5, and 6 show how a simple abacus can be taken apart by using removable wood screws to hold each rod (with ten beads per rod) in its place. And by removing one wood screw that holds a rod In its place; this rod and its ten beads can also be removed from the simple abacus. And a number of lower rods can be removed in this way, to lessen confusion for the beginner, A simple alternative is to use a long rope that can be threaded through each set of two holes, (one hole in the left edge piece, and one hole in the right edge piece.) And this rope is to be permanently secured near the top hole in the left edge piece. But the other end of this rope can be tied in a knot that can be untied. And this permit's the rope to be unthreaded from each of the lower rows. And on each segment of rope are ten beads. And by either of these ways, the adult who is supervising the use of this simple abacus can remove one or more rows of beads, or replace one or more rows of beads as this appears desirable or needed.

5. To lessen possible confusion in the beginning learner, that may be caused by too much information from a gird of one hundred numbers is a type of augmentation, that is a large sheet of opaque blank paper or plastic that may be used to cover the numbers in the counter area below the “counter beads”; when this area is not being used a that moment, on that day. And as the beginning learner masters working with ten beads on the first row of beads; this large opaque sheet of paper or plastic may be moved progressively down, to reveal the next row of numbers to be worked with. And as additional rows of beads with ten beads per rod are mastered by a beginner; this opaque sheet of paper or plastic may be again lowered to reveal the next set of ten numbers. And this may be repeated in a progressive way until the bottom row of numbers have been revealed and mastered. This mask that can be partly cover the bottom grid of numbers is illustrated in FIG. 7.

6. This claim is similar to claim 5, but in claim 6, the opaque mask is placed over the lower rows of beads and over the lower rods, while initially revealing the top row of beads on a rod. with ten beads per rod (or per segment of rope or wire.). And as the beginning learner progressively masters the numbers of beads on a series of rods, this opaque sheet can be progressively lowered to reveal the next rod (or segment of rope), with its ten beads. And with this type of mask (over, or above) the rods and their ten beads per rod; the tutor, parent, or teacher, does not need to remove the lower rows of beads and rods, as this mask hides these unused beads, plus their potential number from the view of the user of this simple abacus. And this type of mask may permit the use of a less expensive simple abacus with fewer parts, and with fewer problems with dis-assembling and reassembling the many parts. And several pieces of removable tape, or its equivalent, can be used to hold this type of mask in place, by taping this mask to the side edge pieces. This type of mask is illustrated in FIG. 8.

7. This claim is about a special shape of a bead composed of two linked parts. One part of this bead resembles a small tube. A second part of this bead has a large diameter disk like shape. This shape of bead could best be made from plastic by injection molding. This shape of bead in an abacus has three purposes:
1.) to give the user of a simple abacus with an underlying printed augmentation, that contains a grid of numbers, a better view of the individual printed numbers on that underlying grid;
2.) to permit the construction of an abacus of smaller size than is required by spherical shaped beads; and
3.) to make the disk in this shape of bead, to be large enough in size to make It difficult or impossible to be sucked or aspirated into a small child's throat and lungs. And a bead of this size, shape; and design, with a large enough size, would make it safer to have removable rods with ten beads per rod as a tool to help young learners learn to count to ten; and then to twenty; and then to thirty and so on until one hundred is reached. See FIGS. 21, 22, 23, and 24 that illustrate this shape of this type of bead, and its use.

8. is for a variety of augmentations that are based on a grid of numbers that are organized in a numerical sequence from # 1 to # 100, where this grid of numbers lies under the beads in the “counter area”. And a simple abacus may contain more or less than 100 beads. The number of beads in a simple abacus depends on the number of rods or on the number of rope or wire segments used in this particular abacus, Thus the number of rod like segments used in a simple abacus determines the total number of beads in a simple abacus. Almost always in a simple abacus, each rod or its linear equivalent contains ten bead like objects. The range of modified augmentations noted below in claims 9 through 12 are an extension of the use of the # 1 to # 100 number grid as described in claim # 1.

9. is a augmentation that illustrates or shows only the even numbers of: #2, # 4, # 6. # 8, # 10, # 12, and so on until # 100 is reached. (And this is an extension of claim # 1.) This augmentation can also help beginners learn to count by two's and also learn the two's multiplication tables And with this augmentation a beginning learner can experience in a concrete way, by their own experience of moving two beads at a time, and seeing the number of beads grow in size, by observing the even numbers above the beads that have even numbers above them in this grid of even numbers. (In this grid of even printed numbers, the odd numbers have been deleted. This is illustrated in FIG. 12

10. is an augmentation that shows only the odd numbers from #1 to # 99; (or higher, if more than ten rods or their linear equivalents are used in this simple abacus with this type of augmentation), And this type of augmentation helps children understand the “odd numbers” from #1 to # 99, by starting with #1, and then adding two beads at a time to the previous beads, until the # 99 is reached. And by practice and work with this augmentation, a beginning learner can gain a much clearer understanding of what “odd numbers” are about. (To get the odd numbers, the even numbers have been deleted from the printed grid. And FIG. 13 illustrates this type of augmentation.

11. is an augmentation that is constructed to help beginning or intermediate learners understand the “times three multiplication tables”; and it extends beyond the number thirty to reach the number ninety nine. (And it could be extended to a larger number than # 99, if there were more than ten rods or their linear equivalents on this type of augmentation.) And in this augmentation, all numbers that are not divisible by # 3 have been deleted. This is illustrated in FIG. 14.

12. is an augmentation that is constructed to help young children learn the fives and tens multiplication tables. And again the learner is actively involved in moving five or ten beads at a time from the non counter area into the counter area where these groups of five or ten beads are pressed against the counter bar, in a progressive manner, starting first with the top row of beads and the moving to the second, third, and fourth rows of beads, and further as row of ten beads is moved into the counter area. And all numbers that cannot be divided by five are deleted. And claim 12 is partly illustrated in FIG. 15.

13. is an augmentation that extends under the entire “counting area” and ‘non-counting area” in an abacus without a bottom, such as is illustrated in FIG. 3. And in previous claims the illustrations of the augmentation sheet only extended to the area under the beads when these beads were in the “counting area”, and these beads or their touching neighbor beads were in contact with the counter bar. In claim 13, the printed or hand written augmentations extend under both the ‘counting area” and the ‘non-counting area”. (where the beads have no value at that moment.) And FIGS. 25, 26, 27, and 28 illustrate this larger augmentation and its use with a simple abacus without a bottom, as in FIG. 3. This larger augmentation sheet makes it easier to use an abacus without a bottom.

14. is an augmentation that uses a different grid of numbers from the previous augmentations. And in this different type of augmentation, the grid of numbers are the “products” of a multiplier and a multiplicand, where both the multiplier and multiplicand are both a′number ten or under. And with this different augmentation, a different set of operational rules applies. (In the previously claimed augmentations, the numbers were all in a numerical sequence, from #1 to # 100; and with ten numbers per row starting in the top row; and progressing in a sequential manner to the bottom row of numbers. And for this previous type of augmentation to work correctly, all of the previous rows of beads had to be completely full of “counter beads” for the augmentation to work correctly with the lower rows of beads.) This rule does not apply to this different type of augmentation in claim 14, where the numbers in the grid are the “products” of a multiplier and a multiplicand (both of which are ten or under in number.) And In this different type of augmentation the rule is that to get accurate results, the user should build squares or rectangles of beads by using the horizontal and vertical axes of the number selected from: A.) the left column (the multipliers) and from: B.) the multiplicands, (in the top row) of numbers; where these two numbers are to be to be multiplied together. And in building these squares and rectangles of beads, the user should always start with the # 1 bead in the top left hand corner of the grid of numbers. And then use the horizontal and vertical axes of the numbers they have chosen to form squares or rectangles of beads. And If squares and rectangles of beads are not built in this way, this augmentation for learning the multiplication tables will not work properly. And when the proper squares or rectangles of beads are built, the “product” number of this multiplier times this multiplicand will appear above the lower right hand bead of this square or rectangle of beads. See FIGS. 10, 17, 18, 19, and 20 for illustrations of this.

15. is an augmentation that is also a blank sheet. A blank sheet placed under the grid of beads and can have several uses: 1.) the user can write in the numbers of each of the beads as he or she moves the beads from the non-counter area into the counter area, thus helping consolidate his or her memory of this number sequence; and to also remember the base of ten for our numbering system; 2.) another person can write in part of the numbers on this blank augmentation, and have the child user complete writing in the numbers in this grid of numbers. And 3.) Another person can write in numbers: #1 to # 10, in the left hand column, which are to become the multiplier numbers. And also write in letters of the alphabet (or other symbols) in the top row, which are to become numbers or symbols for the multiplicand in the top row; (except for # 1, which is left as #1.) And with this third use of a blank sheet, the grid of numbers can contains the “products” of two numbers of ten or under. And this third use of a blank augmentation can be used to help more advanced users learn how to solve equations with one unknown number. And the student user can then learn how to set up this type of equation, and also learn from his or her active involvement in this type of math process how to solve other equations with one unknown number. And the product number of a multiplier number times a multiplicand letter or symbol will always appear in the bottom row of beads on the right hand side of this square or rectangle of beads; if the pattern of beads is the same as in FIG. 10. See FIGS. 10, 11, and 12 for illustrations of this process.
